(19) United States
(12) Patent Application Publication
(10) Pub. No.: US 2026/0253372 A1
(43) Pub. Date: Aug. 27, 2026

(54) IDENTIFYING MISLABELS, OUTLIERS AND MISSING LABELS IN OBJECT DETECTION AND SEMANTIC SEGMENTATION DATASETS

(71) Applicant: Hirundo LTD, Binyamina-Givat Ada (IL)

(72) Inventors: Shmuel Yonatan HAYOUN, Kfar HaMaccabi (IL); Michael LEYBOVICH, Afula (IL); Oded SHMUELI, Nofit (IL)

(73) Assignee: Hirundo LTD, Binyamina-Givat Ada (IL)

(21) Appl. No.: 19/403,084

(22) Filed: Nov. 27, 2025

Related U.S. Application Data
(60) Provisional application No. 63/727,238, filed on Dec. 3, 2024.
(60) Provisional application No. 63/734,790, filed on Dec. 17, 2024.

(51) Int. Cl. G06V 10/72; G06V 10/25; G06V 10/764; G06V 10/774; G06V 10/776; G06V 10/778; G06V 10/82; G06V 20/70

(52) U.S. Cl. CPC G06V 10/72; G06V 10/25; G06V 10/774; G06V 10/776; G06V 10/7788; G06V 20/70; G06V 10/764; G06V 10/82

(57) ABSTRACT

There is provided method comprising: generating an adapted training dataset of adapted images by extracting portions of an image delimited by a respective boundary for each image of a training dataset for depicting candidate anomalies of the images and corresponding adapted labels comprising class designations of objects associated with each adapted image, training a classifier on the adapted training dataset, computing a stepwise self-influence value for each adapted image, aggregating the stepwise self-influence values to obtain a self-influence value for each adapted training image, and for a certain adapted training image with self-influence value meeting a requirement indicating likelihood of being anomalously labeled, correcting a perceived anomaly in an indicated anomalously labeled image of the training dataset corresponding to the certain adapted training image by correcting the class designation and/or the bounding box of the object of the indicated anomalously labeled image, or removing the indicated anomalously labeled image.

### RELATED APPLICATIONS

This application claims the benefit of priority under 35 USC § 119(e) of U.S. Provisional Patent Application No. 63/727,238 filed on Dec. 3, 2024, and of U.S. Provisional Patent Application No. 63/734,790 filed on Dec. 17, 2024, the contents of which are all incorporated by reference as if fully set forth herein in their entirety.

### BACKGROUND

The present invention, in some embodiments thereof, relates to training datasets for machine learning models and, more specifically, but not exclusively, to identifying mislabels, outliers, and/or missing labels in the training datasets.

Images depicting objects labelled with an indication of the object are used to train machine learning models for identifying and/or detecting objects of a similar type in new images. For example, images depicting different cats are labelled with bounding boxes encompassing the cats. A machine learning model trained on such training dataset detects a cat in a new image.

Computer vision (CV) and artificial intelligence (AI) are transforming the way machines interpret and understand the world. By combining advanced AI techniques, such as deep learning, with the processing of visual data, CV enables machines to automatically perform tasks typically requiring human visual perception. For example, from autonomous driving to medical diagnostics, computer vision applications span across various industries.

### SUMMARY

According to a first aspect, a computer implemented method of removing and/or correcting at least one anomaly in a training dataset for training a machine learning model, comprises: wherein the training dataset comprises a plurality of images, each image depicting a plurality of objects, and a collection of labels, each label corresponding to a specific object in a specific image and comprising a class designation selected from a plurality of class designations and geometric coordinates defining a delimiting boundary of the corresponding specific object within the corresponding specific image, generating an adapted training dataset of adapted images by extracting portions of the image delimited by the respective bounding boxes for each image of the training dataset and/or by generating new images and/or adapting existing images for depicting candidate anomalies of the images and corresponding adapted labels comprising the class designations of the objects associated with each adapted image, training a classifier on the adapted training dataset wherein during or after the training a stepwise self-influence value for each adapted image is computed, the stepwise self-influence value indicating the amount by which the classification loss on the adapted image is reduced as a result of changes in the tunable parameters of the classifier made in a training step and attributed to the presentation of the adapted image itself, aggregating a plurality of the stepwise self-influence values for each adapted training image to obtain a self-influence value for each adapted training image, and for a certain adapted training image with self-influence value meeting a requirement indicating high likelihood of being anomalously labeled, for the object corresponding to said adapted training image, correcting a perceived anomaly in an indicated anomalously labeled image of the training dataset corresponding to the certain adapted training image by correcting the class designation and/or the bounding box of the object of the indicated anomalously labeled image, or removing the indicated anomalously labeled image from the training dataset.

According to a second aspect, a system for removing and/or correcting at least one anomaly in a training dataset for training a machine learning model, comprising: at least one processor executing a code for: wherein the training dataset comprises a plurality of images, each image depicting a plurality of objects and a collection of labels, each label corresponding to a specific object in a specific image and comprising a class designation selected from a plurality of class designations and geometric coordinates defining a delimiting boundary of the corresponding specific object, generating an adapted training dataset of adapted images by extracting the portion of the image delimited by the bounding boxes for each image of the training dataset and/or by generating new images and/or adapting existing images for depicting anomalies of the images, training a classifier on the adapted training dataset, wherein during or after the training, a stepwise self-influence value for each adapted image is computed, the stepwise influence value indicating the amount by which the classification loss on the adapted image is reduced as a result of changes in the tunable parameters of the classifier made by executing a training procedure on the adapted image itself, aggregating a plurality of the stepwise self-influence values for each adapted image to obtain a self-influence value for each adapted image, and for a certain adapted image with influence value meeting a requirement indicating likelihood of being anomalously labeled, correcting at least one label in an anomalously labeled image of the training dataset corresponding to the certain adapted image by correcting the class designation and/or the bounding box of the object of the anomalously labeled image, or removing the anomalous image from the training dataset.

According to a third aspect, a computer implemented method of labelling objects that are missing labels in a training dataset for training a machine learning model, comprises: wherein the training dataset comprises a plurality of images, each image depicting a plurality of objects labelled and a label comprising a collection of label vectors, each label vector corresponding to a specific object in the image and including a class designation and geometric coordinates defining a bounding box for the corresponding specific object, generating an adapted training dataset of adapted images by blurring the plurality of objects of the plurality of images of the training dataset, feeding the adapted training dataset into an object detector model, and in response to the object detector model generating a bounding box on an adapted image with blurring, at least one of: mapping the generated bounding box to the image corresponding to the adapted image, and removing the image corresponding to the adapted image from the training dataset.

In a further implementation form of the first, second, and third aspects, further comprising training the machine learning model on a training dataset with corrected anomalously labeled images.

In a further implementation form of the first, second, and third aspects, further comprising: accessing a trained machine learning model previously trained on the training dataset, and applying an unlearning process to the trained machine learning model for unlearning the indicated anomalously labeled image.

In a further implementation form of the first, second, and third aspects, the delimiting boundary of a specific object within a specific image from the training dataset is a bounding box or a closed polygon.

In a further implementation form of the first, second, and third aspects, the stepwise self-influence value of a specific adapted image is recorded after executing a training procedure on a plurality of adapted images.

In a further implementation form of the first, second, and third aspects, the stepwise self-influence value of a specific adapted image is computed after training the classifier using a plurality of states of the classifier using checkpoints saved during training.

In a further implementation form of the first, second, and third aspects, each adapted image is created from a single bounding box or closed polygon on an image included in the training dataset by extracting portions of the image delimited by an extended bounding box (EBB) including a portion of the image that includes the bounding box and a context area surrounding the bounding box or closed polygon, the adapted training image label is the class designation corresponding to the single bounding box.

In a further implementation form of the first, second, and third aspects, the class designation of the object in the image of the training dataset with bounding box corresponding to the EBB of the adapted training image is corrected to the class designation outputted by the classifier.

In a further implementation form of the first, second, and third aspects, further comprising: computing stepwise during or after training the influence value for the adapted image with respect to (i) other adapted images of the same class designation as the respective adapted image and with respect to (ii) other adapted images of a different class designation as the respective adapted image, said influence value indicating the amount of loss reduction of the other adapted image due to the presentation of the adapted image during training, in response to an aggregation of a plurality of the influence values separately with respect to (i) and (ii) meeting a requirement indicating a second likelihood of being anomalously labeled, correcting the class designation of the object of the adapted training image in the label of the image of the training dataset containing the object to the class designation of the different class designation, and in response to an aggregation of a plurality of the influence values with respect to (i) meeting the requirement and with respect to (ii) not meeting the requirement, marking the object of the adapted training image of the image of the training dataset containing the object as an outlier object of the class designation of the object.

In a further implementation form of the first, second, and third aspects, the adapted training dataset is created by: for a subset of the plurality of images of the training dataset, creating a plurality of augmented images by adapting the at least one label of the subset to generate a plurality of augmented labels, setting the class designation of said object in the augmented image label to a class designation not in plurality of class designations indicating the mislabeling of the bounding box, adding said augmented images to the training dataset forming an augmented training dataset, obtaining adapted training images from said augmented training dataset, wherein training comprises training the classifier over said adapted training images, for an adapted image with self-influence value meeting the requirement indicating likelihood of being anomalously labeled, correcting the bounding box of the object of the image of the training dataset, or removing the image from the training dataset.

In a further implementation form of the first, second, and third aspects, the plurality of augmented images are created by augmenting the at least one label, wherein augmenting is selected from: shifting each of the delimiting boundary coordinates by a constant value, and enlarging and/or shrinking the delimiting boundary.

In a further implementation form of the first, second, and third aspects, the bounding box of the object of the image in the training dataset is corrected via a user interface according to the class designation of the bounding box outputted by the classifier on an image with self-influence value meeting the requirement.

In a further implementation form of the first, second, and third aspects, at least one image of the training dataset depicts at least two overlapping objects wherein a first object at least partially covers a second object and/or at least two overlapping bounding boxes, creating a number of duplicates of the adapted training dataset, the number corresponding to the number of the plurality of class designations, wherein the j'th duplicate dataset is associated with the j'th class designation where j ranges over class designations, for the j'th duplicated image of each duplicated adapted training dataset, labelling each object with a first class designation indicating true when the label of the object in the image of the adapted training dataset is the same as the class designation associated with the j'th duplicate dataset, and labelling each object with a second class designation indicating false when the label of the object in the image of the adapted training dataset is different than class designation associated with the j'th duplicate dataset, wherein training comprises training a respective binary classifier on each duplicated adapted training dataset, wherein during the training, a stepwise self-influence value for each image is computed, the stepwise self-influence value indicating a loss reduction amount of the image that is attributed to the presentation of the image to the respective binary classifier during the training of said classifier, for a respective image in each duplicated adapted training dataset labelled with true, find and remove another image in this duplicated adapted training dataset labelled with false corresponding to the same image in the image training dataset, wherein a bounding box of the another image overlaps according to a requirement for a bounding box of the respective image, assigning zero to the self-influence value of a removed image, and providing images with self-influence value meeting the requirement indicating likelihood of being anomalously labeled for correction or removal.

In a further implementation form of the first, second, and third aspects, identifying at least one image of the training dataset depicting at least two overlapping bounding boxes, for each identified image, replacing the at least two overlapping bounding boxes with a single new bounding box that at least covers a union of the overlapping at least two bounding boxes, and assigning a multi-label class designation created as a union list of the class designations of the overlapping at least two bounding boxes, wherein the adapted training dataset includes an image of the single new bounding box and the multi-class label designation, training comprises training a multi-class classifier on the adapted training dataset, wherein during the training, a class wise self-influence value for each image is computed in a stepwise manner, the class wise self-influence value indicating a loss reduction amount of the image that is attributed to the presentation of the image to the multi-class classifier during the training, and providing images with aggregated class-wise self-influence value meeting the requirement indicating likelihood of being anomalously labeled for correction or removal.

In a further implementation form of the first, second, and third aspects, further comprising creating a first sub-dataset, by creating a copy of each image of the plurality of images of the training dataset overlaid with a visual representation of the labels of the plurality of objects, and creating a first set of proxy images from the first sub-dataset labelled with a label indicating fully annotated image, selecting a subset of images of the training dataset, creating new images for the subset by excluding a subset of labels of the subset of images, and creating a second sub-dataset for the new images, and creating a second set of proxy images from the second sub-dataset labelled with a label indicating partially annotated image, generating the adapted training dataset including a proxy training dataset including the first set of proxy images and the second set of proxy images, wherein the classifier is trained on the adapted training dataset, for a proxy image with self-influence value meeting a requirement indicating likelihood of being anomalously labeled, providing the corresponding image of the images of the training dataset for correction or removing the corresponding image from the training dataset.

In a further implementation form of the first, second, and third aspects, further comprising: generating the adapted training dataset including an objectness dataset from the training dataset, wherein an objectness image of the objectness dataset includes an image of the training dataset and an objectness map of the image of the training dataset, wherein the objectness map comprises a mask over pixels including a binary representation of existence of objects of interest in the image indicated by a center of mass position of each object in the image, wherein a pixel designates a position in space and optionally a class designation, wherein training the classifier comprises training an objectness predictor model on the objectness dataset using an objectness loss function that measures a distance between the objectness map of the objectness image and a predicted objectness map outputted by the objectness predictor model, wherein the objectness predictor model is trained to generate pixelwise binary classifications across a predicted objectness map with the same shape as the objectness map of the objectness image, wherein the stepwise self-influence values are computed pixelwise, for an objectness image with pixels having aggregated self-influence value meeting a requirement indicating likelihood of a missing object, adding a bounding box for the object of the objectness image, or removing the image corresponding to the objectness image from the training dataset.

In a further implementation form of the first, second, and third aspects, the requirement further indicates that the pixel having aggregated self-influence value meeting the requirement is at least a predefined distance away from another bounding box center of mass.

In a further implementation form of the first, second, and third aspects, further comprising generating respective class-wise connected components by analyzing the plurality of labels of a respective semantic mask indicating designated class per pixel of each respective image, for each respective component of the class-wise connected components, generating a proxy object-detection-like label including a bounding box equal to a minimal bounding rectangle of the component, wherein the adapted image includes the proxy object-detection-like label wherein pixels of the image that belong to each respective component are distinguished from pixels of the image that do not belong to the respective component, the adapted image further includes a class designation for the component according to the class designation of the pixels of the component.

In a further implementation form of the first, second, and third aspects, further comprising: creating error images by generating copies of at least a subset of the adapted images and generating a plurality of labelling errors for each respective copy of the copies, and adding the error images to the adapted training dataset.

In a further implementation form of the first, second, and third aspects, a connected component contains pixels of the same class designation and includes at least one of: (i) pixels having a common dimension value and another value differing by one, (ii) two pixels having a value in each dimension differing by no more than one, and does not include: (iii) a set of no more than a predefined number q of pixels that when classified to a different class than its class designation split the component into two or more components.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a block diagram of components of a system for identifying and/or removing and/or correcting an anomaly in a training dataset for training a machine learning model, in accordance with some embodiments of the present invention;

FIG. 2 is a schematic depicting examples of geometric mislabels, in accordance with some embodiments of the present invention;

FIG. 3 is a schematic depicting examples of missing labels, in accordance with some embodiments of the present invention;

FIG. 4 is a schematic depicting examples of overlapping labels, in accordance with some embodiments of the present invention;

FIG. 5 is a flowchart of a method of identifying and/or removing and/or correcting an anomaly in a training dataset for training a machine learning model, in accordance with some embodiments of the present invention;

FIG. 6 is a flowchart of a method for identifying objects missing labels in a training dataset for training a machine learning model, in accordance with some embodiments of the present invention;

FIG. 7 is a flowchart of a method for identifying anomalously labeled bounding boxes, in accordance with some embodiments of the present invention;

FIG. 8 is a flowchart of a method for identifying mislabels and outliers, in accordance with some embodiments of the present invention;

FIG. 9 is a flowchart of a method for error clauses, in accordance with some embodiments of the present invention; and

FIG. 10 is a flowchart of a method for identifying undetected objects, in accordance with some embodiments of the present invention.

### DETAILED DESCRIPTION

The present invention, in some embodiments thereof, relates to training datasets for machine learning models and, more specifically, but not exclusively, to identifying mislabels, outliers, and/or missing labels in the training datasets.

As used herein, the term “anomaly”, such as an anomaly in the training dataset for training a machine learning model, refers to, for example, one or more of: mislabeling (e.g., incorrect category assigned), outliers, and missing labels, in the training dataset. The terms anomaly and error are used interchangeably.

As used herein, the terms classifier, detector, and machine learning model, may sometimes be interchanged. For simplicity, the term classifier is used more often, but it is to be understood that the classifier may be replaced and/or augmented by a detector model.

As used herein, the term image (of the training dataset) is an exemplary and not necessarily limiting implementation of labelled dataset of the training dataset. Other data representations and/or data structures may be used instead of the image and/or in additional to the image, for example, sensed signals (e.g., ECG, EEG), radar, audio, and others, for example, as described herein.

As used herein, the term record refers to an image (depicting multiple objects) and to the label. When the image and the label are discussed, in some embodiments it may be implied that the image and the label are arranged into the record.

As used herein, the term bounding box is not meant to be necessarily limiting. It is to be understood that the bounding box may be replaced by a delimiting boundary, such as a closed polygon and/or another shaped border encompassing, optionally closing around, an object. The terms bounding box and delimiting boundary may sometimes be used interchangeably.

As used herein, the terms example and record, or example and image and label, are sometimes interchangeable.

As used herein, the terms class designation and classification category may sometimes be interchanged.

As used herein the terms label and label vector are used interchangeably.

As used herein the term labeling and marking may sometimes be interchanged.

An aspect of some embodiments of the present invention relates to systems, methods, computing devices, and/or code instruction (stored on a data storage device and executable by one or more processors) for identifying one or more anomalies in a training dataset, for example, mislabels and/or missing labels. The anomalies may include outliers, which may appear as errors such as mislabels but may actually be correct. The training dataset may be designated for training one or more machine learning (ML) models, for example, for object classification tasks (e.g., where the ML model generates a class designation for an input image and/or for each one of multiple objects in the image selected from multiple defined class designations) and/or for object detection tasks (e.g., where the ML model generates a bounding box for an identified object). The training dataset includes multiple images, where each image depicts one or more objects. The training dataset includes a collection of labels. Each label corresponds to one (i.e., specific) object in a specific image. Each label further includes a class designation selected from multiple class designations and indication (e.g., geometric coordinates) delimiting a boundary for the corresponding specific object within the corresponding specific image. At least one image depicts multiple objects associated with multiple different bounding boxes. The multiple objects and bounding boxes may be associated with multiple different class designations, or a single class designation. An adapted training dataset of adapted images is created from the images of the training dataset (also referred to herein as the original images of the original training dataset). The adapted images may be created using one or more image processing approaches, for example, by extracting portions of the image delimited by the respective bounding boxes (optionally with a surrounding added margin) from the images of the training dataset where the adapted image includes the extracted portion of the image in the bounding box (optionally with the added margin), by generating new images depicting candidate anomalies of the images (e.g., synthetic anomalies representing possible anomalies that may exist which may be generated for example by a generative model), by adapting the images (e.g., resizing bounding boxes), and/or by generating new data based on the images (e.g., defining new class designations). A classifier is trained on the adapted training dataset. During and/or after the training, a stepwise self-influence value is computed for each adapted image. The stepwise self-influence value is computed for each adapted image. The stepwise self-influence value indicates the amount by which the classification loss on the adapted image is reduced as a result of changes in the tunable parameters of the classifier made in a training step and attributed to the presentation of the adapted image itself.

The adapted training dataset is designed to “magnify” anomalies in the original training dataset, for increasing the self-influence values when such “magnified” anomalies are presented to the classifier in the adapted images during training. The adapted training dataset is designed to statistically significantly increase the self-influence values when the classifier is trained on the adapted training dataset in comparison to training the classifier on the original training dataset. Multiple stepwise self-influence values are aggregated for each adapted training image to obtain a self-influence value for each adapted training image. The self-influence values of the adapted training images are analyzed, for example, adapted training images are ranked according to the self-influence values. One or more adapted images with self-influence value meeting a requirement indicating high likelihood of being anomalously labeled (e.g., threshold), for the object corresponding to the adapted training image, may be identified. The images of the training dataset corresponding to the identified adapted images (i.e., the images which provided the basis for generation of the identified adapted images) may be identified. The identified images of the original training may be corrected, for example, by correcting the perceived anomaly in an indicated anomalously labeled image of the training dataset corresponding to the certain adapted training image, by correcting the class designation, assigning a class designation where one was missing, moving the bounding box, resizing the bounding box, and/or adding a bounding box where one was missing, of the object of the indicated anomalously labeled image. Alternatively or additionally, the identified anomalously labeled image(s) are removed from the original training dataset. The training dataset with corrected and/or removed images may be used for training the ML model. Alternatively, in cases where the ML model has already been trained on the original training dataset with anomalously labeled images, the trained ML model may undergo an unlearning process for unlearning the identified anomalously labeled image.

The label of an image (or adapted image, or anomalously labeled image) includes multiple components, optionally implemented as label vectors (or labels), such as a collection of label vectors. Each label vector corresponds to one specific object or segmented region of the image. Each label vector includes the class designation of the corresponding object and indication of the location of the corresponding bounding box. The label vector may be implemented as a tuple, of the form, for example, (class designation, a, b, c, d), where a,b,c,d define the bounding box, for example (a,b) denote the coordinates of the upper left corner and (c,d) denote the location of the lower right corner. The label may include additional data, optionally metadata, for example a class designation for the image as a whole, shape and/or size of objects, and/or other metadata. The image may be a two dimensional array of pixels. Each pixel may be represented as a vector of value in the range [0,1] where the length of the vector is 1 for grayscale images, 3 or 4 for color images, and the like. The coordinates denoted a,b,c,d may be with respect to the two dimensional array representing the image.

At least one embodiment described herein addresses the technical problem of detecting anomalies in a training dataset for training a ML model, for example, mislabeling, outliers, and/or missing labels. At least one embodiment described herein addresses the technical problem of improving performance of a trained ML model, by reducing anomalies in the training dataset used to train the ML model by correcting and/or removing identified anomalously labeled images and/or corresponding anomalous labels from the training dataset. At least one embodiment described herein improves the technical field of machine learning, by detecting anomalies in a training dataset for training a machine learning model. The anomalies may be in the image and/or in the label of the image. At least one embodiment described herein improves the technical field of machine learning, by improving performance of a trained machine learning model by correcting and/or removing anomalies in a training dataset for training the machine learning model. At least one embodiment described herein improves upon prior approaches of detecting anomalies in a training dataset for training a machine learning model, for example, manual approaches or leaving the errors undetected. At least one embodiment described herein provides the practical application of improving performance of a machine learning model trained on a training dataset, by removing anomalously labeled images and/or correcting the anomalies (e.g., labels) associated with the images. The machine learning model trained on the training dataset with reduced or eliminated anomalies has improved performance in comparison to training on the training dataset that includes the anomalies.

In training machine learning models, optionally neural networks, on data for tasks, such as detection and/or identification of objects, some data used for training may be mislabeled in various ways, for example, mispositioned labels, misshaped labels, wrong class designations, and the like. Labels may also be missing, for example, an object was not detected within an image. Such mislabeling may lead to underperformance of the resulting trained machine learning model. At least one embodiment described herein provides methods for alleviating such technical problems due to mislabels, designed to be implemented on various computing platforms for object detection and/or image segmentation tasks.

The technical problem is particularly challenging for images with multiple objects which are associated with multiple different bounding boxes labelled with multiple different class designations or with a single category (i.e., the multiple objects are all of the same category). The problem is even more difficult where the objects and/or their bounding boxes overlap. Such images are particularly prone to anomalies due to the multiple presence of different objects which may overlap. Classifiers trained on such images are at increased risk of errors in identifying and/or classifying the different.

Machine learning models trained on training datasets that include such images with multiple objects that include anomalies have reduced performance due to training on the anomalously labeled images. By correcting the anomalously labeled images or removing the anomalously labeled images from the training dataset, at least one embodiment improves performance of the machine learning model trained on the training dataset with removed and/or corrected anomalously labeled images. The improvement in performance is in comparison to training the machine learning model on the training dataset with the anomalously labeled images present.

Despite the significant successes of AI models in computer vision (CV) applications, they often fall short of reaching their full potential. A major obstacle is the quality of training data, where faulty labeling (including bounding boxes and labels)—whether by humans or machines—leads to inaccuracies in model performance. Detecting mislabeled data is challenging, particularly in large datasets, as the volume of examples can overwhelm human annotators, who tend to tire and overlook errors. At least one embodiment described herein provides a solution to the aforementioned technical problem, which may be used to improve training datasets by identifying training examples that are highly suspect of being anomalous (e.g., mislabeled and/or other anomalies described herein) and/or (2) highlighting outliers. While these outliers may be beneficial if similar examples appear during deployment, their usefulness may require careful consideration from domain experts. At least one embodiment may streamline the dataset refinement process, which may help ensure that AI models are trained on more accurate and/or reliable data, leading to more reliable and often more accurate models.

The following exemplary anomalies in training datasets may be identified using at least one embodiment described herein:
1. Misclassifications: These are semantic labeling errors where the ascribed class to an image (in case of image classification), an object (in case of object detection), a segment (in case of semantic segmentation), etc., are erroneous.
2. Geometric mislabels: These are errors are specific to labels that include a geometric component such as in object detection (bounding box size and position) or semantic segmentation (segment shape), in contrast to, for example, image classification where the labels are exclusively semantic in nature. Such errors can take the form of mispositions, in which the shape and size of the label are correct, but its position is not. For example, a bounding box positioned such that it does not properly encompass the intended object, but would otherwise do so if placed correctly, given its current dimensions. Another example is misshapen labels, where labels are positioned correctly, but their shape and/or size is incorrect. For example, a bounding box positioned such that it does not properly encompass the intended object, but would otherwise do so if resized correctly, given its current position.
3. Missing labels: These are instances of labels that are missing from the entirety or a portion of an example. In object detection may be expressed as a set of actual existing relevant objects in an image that do not have corresponding labels. For example, an image from an animal detection dataset that includes a horse and a cat, where the image's associated set of labels includes a “horse” label, but no “cat” label. In instance segmentation this may be expressed as a set of actual existing relevant instances in an image that are not present/labeled as “background”.
4. Overlapping labels: This is an issue specific to object detection where the bounding boxes of objects occluding one another greatly overlap. This might be the case when the bounding box of an occluded object is required to cover the unseen part of the object as well (e.g., cars, pedestrians, etc. in object detection datasets for automotive applications), or when instances of more than a single class manifest together naturally within the boundaries of a single bounding box (e.g., cracks, scratches and dents in car damage detection datasets). In the first type of case the focused analysis of occluded objects may prove to be challenging because the features of the occluding objects are predominant within their corresponding occluded objects' bounding boxes. In the second type of case, the focused analysis of any single object may prove to be challenging because the features of other objects that often manifest alongside it might be predominant within their bounding boxes.

The aforementioned technical problem is solved by, and/or the aforementioned improvement to technology is provided by, and/or the aforementioned improvement over prior approaches is provided by, and/or the aforementioned practical application is enabled by, generation of the adapted training dataset of adapted images from the images of the training dataset. The adapted training dataset is designed to “magnify” anomalies in the original training dataset, for increasing the self-influence values when such “magnified” anomalies are presented to the classifier in the adapted images during training. The adapted training dataset is designed to statistically significantly increase the self-influence values when the classifier is trained on the adapted training dataset in comparison to training the classifier on the original training dataset.

The adapted images may be created using one or more image processing approaches, for example, by extracting the bounding boxes (optionally with a surrounding added margin) from the images of the training dataset where the adapted image includes the extracted portion of the image in the bounding box (optionally with the added margin), by generating new images depicting candidate anomalies of the images (e.g., synthetic anomalies representing possible anomalies that may exist), by adapting the images (e.g., resizing bounding boxes), and/or by generating new data based on the images (e.g., defining new class designations). A classifier is trained on the adapted training dataset. During the training, a stepwise self-influence value is computed for each adapted image. The stepwise self-influence value indicating a loss reduction amount (of a loss function used for training the classifier) of the adapted image that is attributed to the presentation of the adapted image to the classifier during the training. Multiple stepwise self-influence values are aggregated for each adapted image to obtain a self-influence value for each adapted image. The self-influence values of the adapted images are analyzed, for example, adapted images are ranked according to the self-influence values. One or more adapted images with self-influence value meeting a requirement indicating likelihood of being anomalously labeled (e.g., threshold) may be identified. The images of the training dataset corresponding to the identified adapted images (i.e., the images which provided the basis for generation of the identified adapted images) may be identified. The identified images of the original training may be corrected, for example, by correcting the class designation, assigning a class designation where one was missing, moving the bounding box, resizing the bounding box, and/or adding a bounding box where one was missing. Alternatively, or additionally, the identified image(s) are removed from the original training dataset. The training dataset with corrected and/or removed images may be used for training the ML model. Alternatively, in cases where the ML model has already been trained on the original training dataset with anomalously labeled images, the trained ML model may undergo an unlearning process for unlearning the identified anomalously labeled image.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

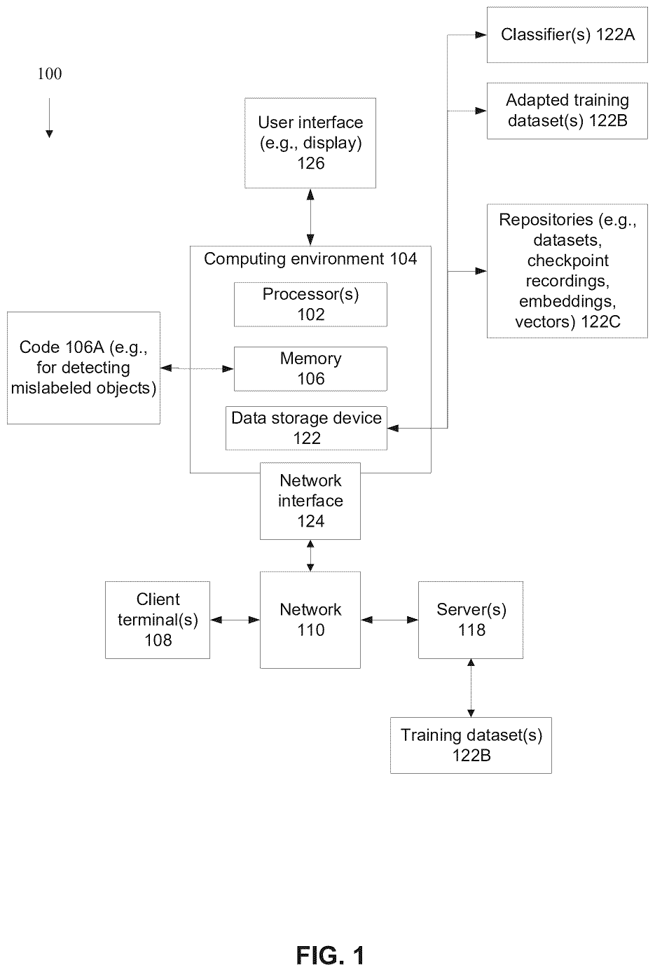

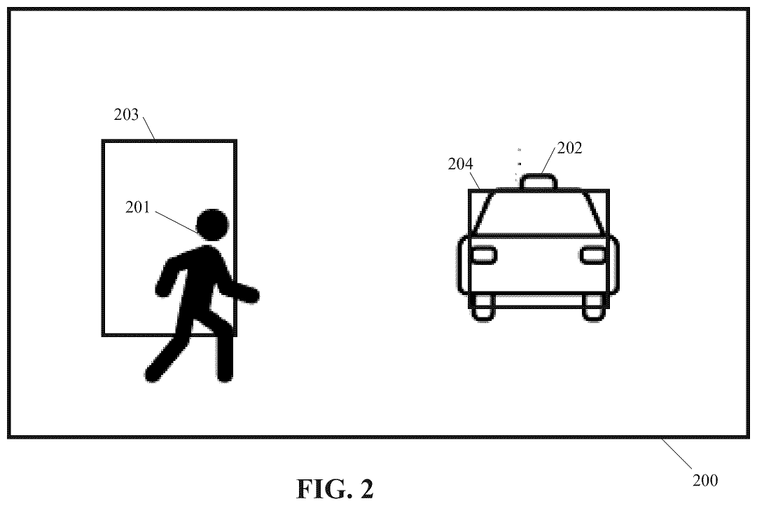

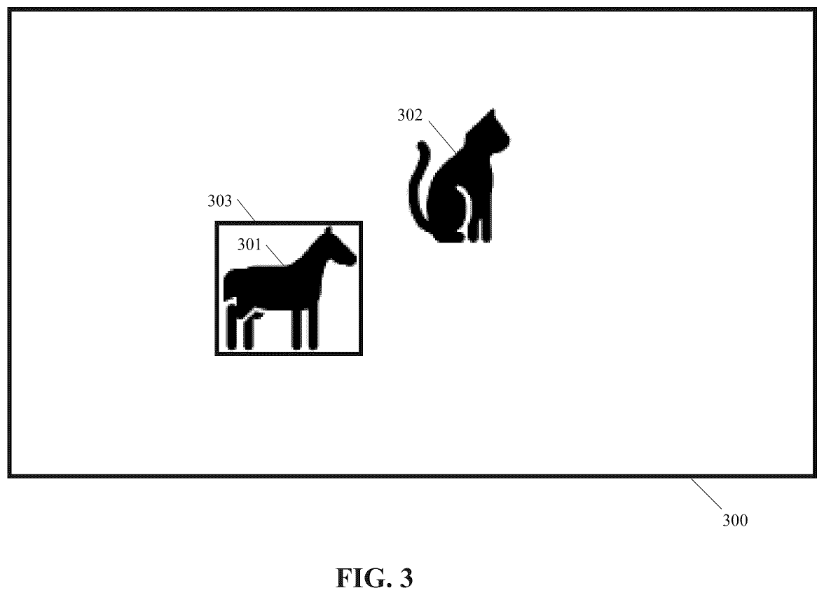

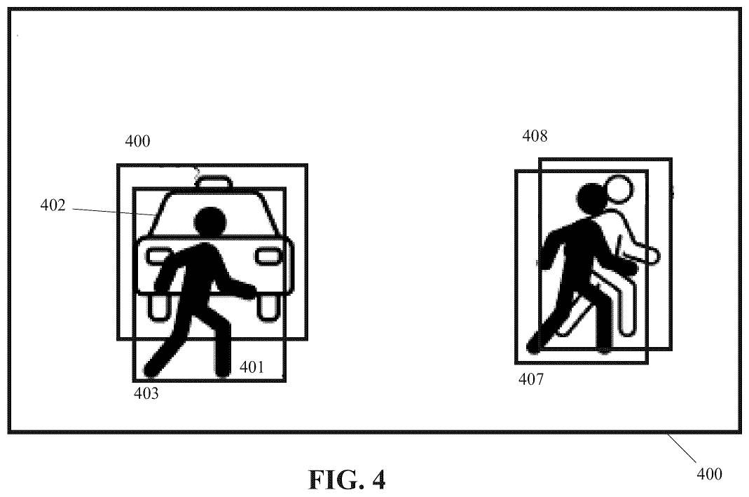

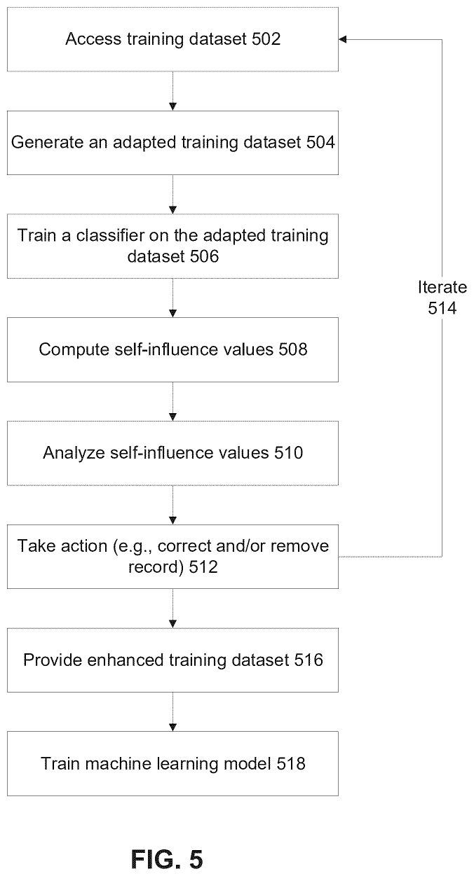

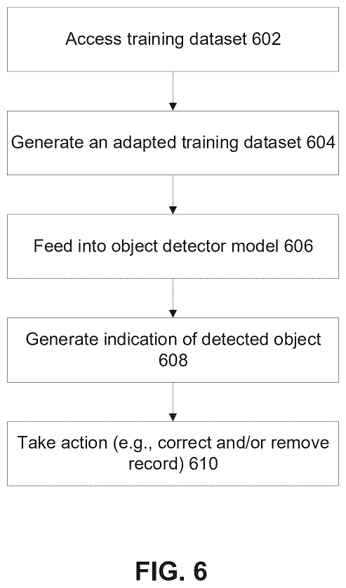

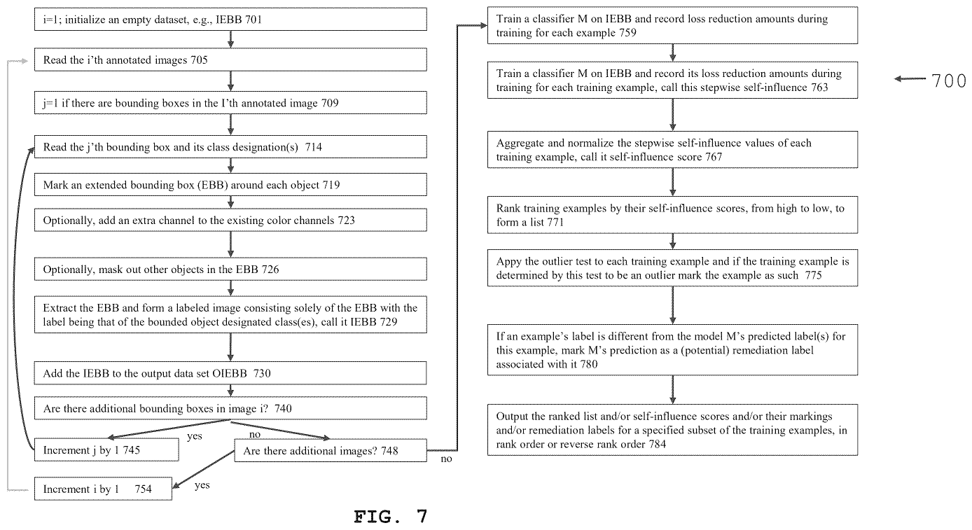

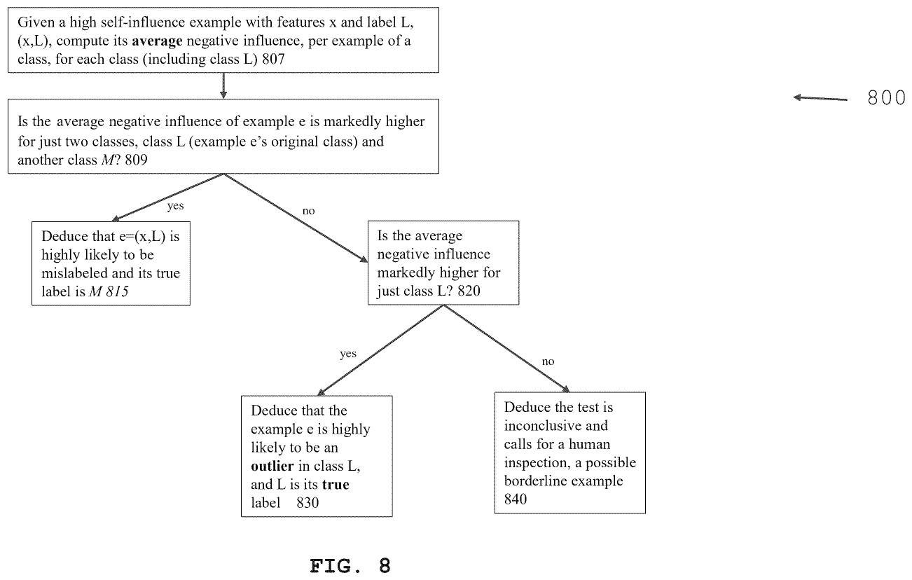

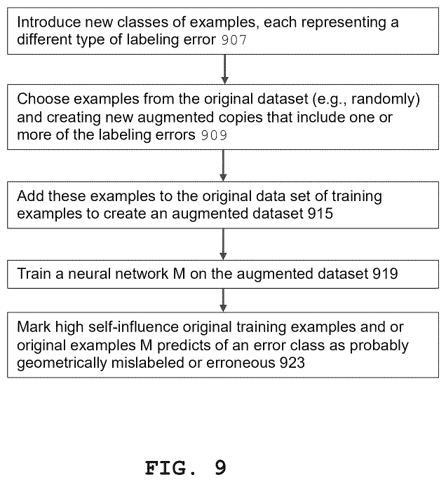

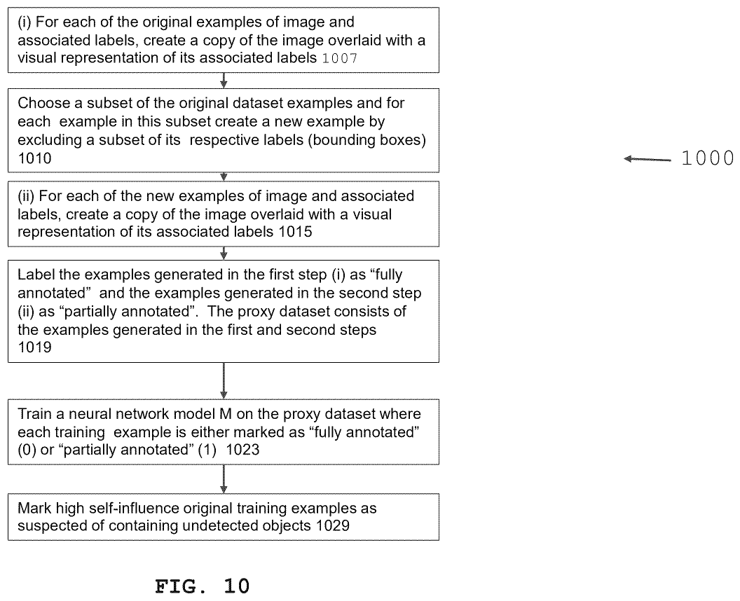

Reference is now made to FIG. 1, which is a block diagram of components of a system for identifying and/or removing and/or correcting an anomaly in a training dataset for training a machine learning model, in accordance with some embodiments of the present invention. Reference is also made to FIG. 2, which is a schematic 200 depicting examples of geometric mislabels, in accordance with some embodiments of the present invention. Reference is also made to FIG. 3, which is a schematic 300 depicting examples of missing labels, in accordance with some embodiments of the present invention. Reference is also made to FIG. 4, which is a schematic 400 depicting examples of overlapping labels, in accordance with some embodiments of the present invention. Reference is also made to FIG. 5, which is a flowchart of a method of identifying and/or removing and/or correcting an anomaly in a training dataset for training a machine learning model, in accordance with some embodiments of the present invention. Reference is also made to FIG. 6, which is a flowchart of a method for identifying objects missing labels in a training dataset for training a machine learning model, in accordance with some embodiments of the present invention. Reference is also made to FIG. 7, which is a flowchart 700 of a method for identifying anomalously labeled bounding boxes, in accordance with some embodiments of the present invention. Reference is also made to FIG. 8, which is a flowchart 800 of a method for identifying mislabels and outliers, in accordance with some embodiments of the present invention. Reference is also made to FIG. 9, which is a flowchart 900 of a method for error clauses, in accordance with some embodiments of the present invention. Reference is also made to FIG. 10, which is a flowchart 1000 of a method for identifying undetected objects, in accordance with some embodiments of the present invention.

Referring now back to FIG. 1, system 100 may implement the acts of the methods described herein, by processor(s) 102 of a computing environment 104 executing code instructions stored in a memory 106 (also referred to as a program store).

Computing environment 104 may analyze a training dataset 122B for detecting one or more errors therein, and/or computing environment 104 may implement one or more other features described herein.

Computing environment 104 may be implemented as, for example one or more and/or combination of: a group of connected devices, a client terminal, a server, a virtual server, a computing cloud and/or other cloud platform such as a virtual private cloud (VPC), a virtual machine, a desktop computer, a thin client, a network node, and/or a mobile device (e.g., a Smartphone, a Tablet computer, a laptop computer, a wearable computer, glasses computer, and a watch computer).

Multiple architectures of system 100 based on computing environment 104 may be implemented. For example:

Computing environment 104 executing stored code instructions 106A, may be implemented as one or more servers (e.g., network server, web server, a computing cloud, a virtual server) that provides centralized services for analyzing errors in training datasets. Services may be provided, for example, to one or more client terminals 108 over network 110, and/or to one or more server(s) 118 over network 110. Server(s) 118 may host one or more training datasets 122B.

Client terminals 108 may provide an indication of a location of training dataset 122B. It is noted that training datasets 122B may be stored and/or hosted in other locations. Services may be provided by computing environment 104 to client terminals 108 and/or server(s) 118, for example, as software as a service (SaaS), a software interface (e.g., application programming interface (API), software development kit (SDK)), an application for local download to the client terminal(s) 108 and/or server(s) 118, an add-on to a web browser running on client terminal(s) 108 and/or server(s) 118, and/or providing functions using a remote access session to the client terminals 108 and/or server(s) 118, such as through a web browser executed by client terminal 108 and/or server(s) 118 accessing a web site hosted by computing environment 104. In an example, a user may use client terminal 108 to request checking a provided training dataset 122B for errors, such as prior to training of a machine learning model. In another example, the training dataset 122B may be hosted by server(s) 118, and computing environment 104 may perform error checking on the training dataset 122B hosted by server(s) 118.

In another exemplary architecture, computing environment 104 may be implemented as a standalone device (e.g., server, client terminal, smartphone) that includes locally stored code instructions 106A that implement one or more of the acts described herein, for locally checking training dataset(s) 122B for errors, and/or other features described herein. The locally stored code instructions 106A may be obtained from a server, for example, by downloading the code over the network, and/or loading the code from a portable storage device, such as by installing an app on a smartphone of a user.

Processor(s) 102 of computing environment 104 may be hardware processors, which may be implemented, for example, as a central processing unit(s) (CPU), a graphics processing unit(s) (GPU), field programmable gate array(s) (FPGA), digital signal processor(s) (DSP), and application specific integrated circuit(s) (ASIC). Processor(s) 102 may include a single processor, or multiple processors (homogenous or heterogeneous) arranged for parallel processing, as clusters and/or as one or more multi core processing devices.

Memory 106 stores code instructions executable by hardware processor(s) 102, for example, a random access memory (RAM), read-only memory (ROM), and/or a storage device, for example, non-volatile memory, magnetic media, semiconductor memory devices, hard drive, removable storage, and optical media (e.g., DVD, CD-ROM). Memory 106 stores code 106A that implements one or more features and/or acts of the method described herein when executed by hardware processor(s) 102.

Computing environment 104 may include a data storage device 122 for storing data, for example, classifier 122A trained on an adapted training dataset 122B, adapted training dataset(s) 122B created from an original training dataset, and/or one or more repositories 122C such as of an original training dataset(s), original training dataset(s) with corrected and/or removed anomalously labeled images and/or corresponding labels, machine learning model trained on the original training dataset(s) with corrected and/or removed anomalously labeled images and/or corresponding labels, checkpoint recordings, embeddings, vectors, and other data described herein. Data storage device 122 may be implemented as, for example, a memory, a local hard-drive, virtual storage, a removable storage unit, an optical disk, a storage device, and/or as a remote server and/or computing cloud (e.g., accessed using a network connection).

As used herein, the terms memory 106 and data storage device 122 may sometimes be interchanged. Use of one of the terms memory and data storage device is not meant to be necessarily limiting with respect to the location where code and/or data is stored. For example, data stored in data storage device 122 may be loaded into memory 106 for execution by processor 102. In another example, reference to data being stored in data storage device 122 may refer to the data being stored in memory 106.

Computing environment 104 may include a network interface 124 for connecting to network 110, for example, one or more of, a network interface card, a wireless interface to connect to a wireless network, a physical interface for connecting to a cable for network connectivity, a virtual interface implemented in software, network communication software providing higher layers of network connectivity, and/or other implementations.

Network 110 may be implemented as, for example, the internet, a local area network, a virtual network, a wireless network, a cellular network, a local bus, a point to point link (e.g., wired or via BlueTooth), and/or combinations of the aforementioned.

Computing environment 104 and/or client terminal(s) 108 include and/or are in communication with one or more user interfaces 126 designed for a user to provide input and/or view output. Exemplary user interfaces 126 include, for example, one or more of, a touchscreen, a display, gesture activation devices, a keyboard, a mouse, and voice activated software using speakers and microphone.

Referring now back to FIG. 2 schematic 200 depicting geometric mislabels which may be detecting using at least one embodiment described herein is presented. Schematic 200 may be used for training a machine learning model, as described herein. Schematic 200 includes a pedestrian (i.e., pedestrian feature) 201, with a mispositioned pedestrian boundary box 203. Box 203 is misplaced and therefore does not fully encompass pedestrian 201, excluding portions of pedestrian 201. Schematic 200 also includes a car 202 (i.e., car features), with a mispositioned car bounding box 204. Box 204 is too small and does not fully encompass car 202, excluding portions of car 202.

Referring now back to FIG. 3, schematic 300 depicting missing labels which may be detecting using at least one embodiment described herein is presented. Schematic 300 may be used for training a machine learning model, as described herein. Schematic 300 includes a horse 301 (i.e., horse features) with a properly positioned horse bounding box 303. Schematic 300 also includes a cat 302 (i.e, cat features) that is missing a bounding box (or other label).

Referring now back to FIG. 4, schematic 400 depicting overlapping labels (e.g., bounding boxes) which may be detecting using at least one embodiment described herein is presented. Schematic 400 may be used for training a machine learning model, as described herein. Schematic 400 includes a first pedestrian (first pedestrian features) 401 overlapping a car (car features) 402. A first pedestrian bounding box 403 encompassing first pedestrian 401 overlaps a car bounding box 404 encompassing car 402. Schematic 400 also includes a second pedestrian (second pedestrian features) 405 overlapping a third pedestrian (third pedestrian features) 406. A second pedestrian bounding box 407 encompassing second pedestrian 405 overlaps a third pedestrian bounding box 408 encompassing third pedestrian 406.

Referring now back to FIG. 5, at 502, a training dataset is accessed, generated, and/or received.

The training dataset may be designated for training and/or may have been used for training, one or more machine learning (ML) models, for example, for object classification tasks (e.g., where the ML model generates a class designation for the image and/or for one or more objects in the image selected from multiple defined class designations) and/or for object detection tasks (e.g., where the ML model generates a bounding box for an identified object).

The training dataset includes multiple images, where each image includes an image depicting one or more objects. Each image is associated with a label including a collection of label vectors (or tuples, or other data representation). Each label vector corresponding to a specific object in the image and including a class designation and geometric coordinates delimiting a bounding box for the corresponding specific object.

The class designation may be selected from multiple defined class designations (e.g., denoted L1, . . . . Lm). The bounding box encompasses the object having the class designation.

At least one image of the training dataset depicts multiple objects associated with multiple different bounding boxes. Each of the multiple objects may be associated with multiple different class designations. Alternatively, or additionally, the image as a whole is associated with a single class designation. For example, an image may depict multiple trees, each with its own bounding box and class designation of “tree”. The image as a whole may have the class designation “forest”.

The challenge is to locate those labels that are misclassified and/or outlier labels.

Visual (i.e., image) and other data may be presented to a machine learning model for training in data files, also known as records or record files. A record (also known as a sample, image or instance) usually has two main components: features and label. The features provide the visual component, and the label describes the image or its constituent artifacts. The label usually has several components out of certain coordinates of artifacts such as objects or segments, a class designation for the whole image and/or its constituent artifacts, designation of shape and size of various constituent artifacts, and any other useful metadata information.

Features may be implemented as a two-dimensional array of pixels. For example, in some implementations, each pixel may be a vector of values in the range [0, 1] where the length of the vector is 1 for grayscale images, 3 for colored images, 4 for colored images, etc. The label may be a list of a finite length vectors, where each vector corresponds to a specific artifact (object) in the image. The first entry may be a class designation for the object, the rest describe the object's bounding box or a polygon (intuitively, a geometric shape containing the pixels of the artifact within the image). The bounding box may be of the form (a, b, c, d) where (a, b) is the upper left coordinates, (c, d) is the lower right coordinates, in the two-dimensional array of pixels.

At 504, an adapted training dataset of adapted images is created from the original images of the original training dataset.

The adapted images may be created using one or more image processing approaches, for example, by:
Extracting the bounding boxes (optionally with a surrounding added margin) from the images of the training dataset where the adapted image includes the extracted portion of the image in the bounding box (optionally with the added margin).
Generating new images depicting candidate anomalies of the images (e.g., synthetic anomalies representing possible anomalies that may exist).
Adapting the bounding boxes of the labels of the images (e.g., resizing bounding boxes).
Adapting the class designations of the labels of the images (e.g., changing one class designation to another class designation, or filling in a missing class designation).
Generating new labels and/or data based on the images (e.g., defining new class designations).
One or combination of the other exemplary approaches described herein.

The adapted training dataset is designed to “magnify” anomalies in the original training dataset, for increasing the self-influence values when such “magnified” anomalies are presented to the classifier in the adapted images during training. The adapted training dataset is designed to statistically significantly increase the self-influence values when the classifier is trained on the adapted training dataset in comparison to training the classifier on the original training dataset.

At 506, a classifier and/or detector, optionally implemented a neural network, is trained on the adapted training dataset. During the training, a stepwise self-influence value is computed for each adapted image and corresponding label (which may be adapted). The stepwise self-influence value indicating a loss reduction amount (of a loss function used for training the classifier) of the adapted image that is attributed to the presentation of the adapted image to the classifier during the training.

A brief description of an exemplary approach for training a deep learning model which includes a neural network and its parameters (weights) is now provided. A supervised training approach for training of a neural network is based on repeatedly presenting the network with training examples. Each example denoted z=(x, y), includes two parts, input denoted x and output denoted y. Based on this presentation, the network predicts an output. This output is compared to the output component of the presented example. Based on the difference between the network output and the example's output, the network parameters are adjusted so that the network's output is “closer” to the example's output. A loss function, denoted [symbol] , is a function that measures the “distance” between the example output and the network's output (upon being presented with the example's features).

It is assumed that the training examples of the training set are presented one by one in some order. Usually, when all training examples have been presented, this concludes an epoch. Based on the implementation of the training process, it may be the case that each training example is presented exactly once during each epoch, however it is also possible to introduce some or all examples more than once during an epoch or that some examples are not presented at all during the epoch. Once an epoch concludes, certain actions may be taken, and another epoch starts until a point when the training process is concluded, for simplicity the end of training coincides with the conclusion of an epoch.

In an exemplary implementation, x is a vector of features and y denotes a class which is one of a finite number L of classes, in this setting a classifier is being trained. The term model is used herein to refer to the neural network. In adjusting weights during training, the gradient of the loss function of the specific training example denoted z is used with respect to (w.r.t) the weights w_t at time t, denoted ∇ [symbol] (w_t, z). The gradient is a vector, and each entry corresponds to a distinct network weight. If there are m such weights, then the gradient defines a direction in m-dimensional space. The direction is such that movement in this direction will maximize the loss of the example w.r.t which the gradient is taken. As, usually, the goal is to minimize the loss (distance to desired output) during training, the network weights when adjusted according to the gradient are changed in the opposite direction (multiplication by minus one). The amount of change is dictated by the learning rate, denoted by η. This training method is referred to as gradient descent, and it comes in many variations, it may be assumed that the simplest form described of gradient descent is used during training. However, it is noted that other approaches may be used.

Training may vary. For example, one training example is not usually presented at a time but rather, to parallelize the process, a batch including a number denoted b of examples is presented and the adjustments to the network's weights is based on the cumulative effect of the b training examples in the batch. The training process is associated with several hyperparameters such as learning rate, momentum and more. In addition, the entire process may be controlled by an optimizer, a system that dynamically adjusts the hyperparameters and controls the overall training process. For simplicity and clarity, the concept of influence described herein is described in the context of the naïve scenario outlined above, and then expanded to more complex settings.

A training set of examples denoted S, a test set of examples denoted Z that are used to test the quality of the neural network's predictions, are provided. For simplicity a validation set is omitted. As the training progresses the total of the loss values over all the training examples is expected to decrease, signifying that overall, the network evolved towards a better prediction. The function [symbol] has two arguments, the network's parameters (weights) w and the example input and output pair of the form (x, y). The training process may start at time t=0 and continue until time t=T. In each time instance t, a single example z_t is presented to the network and at the instance of presentation the state of the weights of the network is denoted as w_t.

Checkpoints may be recorded during the training process. The decisive part of a checkpoint is the weight values at checkpoint time. Various data and/or metadata may be kept within a checkpoint as well, for example, learning rate, loss, accuracy, date and time, software versions used, and human operator. A checkpoint taken at time t is denoted as C_t and the final trained model denoted Mis also checkpoint denoted C_T. Checkpoints may be used post training to obtain various insights regarding the training process, for example in approximating the computation of IdealInfluence.

An overview of model training is now provided:

In the context of neural networks, a model is the result of training a neural network. A model is a computational device implemented via hardware and/or software that can be used to generate predictions. A model is usually created by adjusting model parameters based, usually, on a set of examples presented to the neural network during training. During model training of a neural network (e.g., a feed forward neural network, a convolutional neural network, a recursive neural network, a transformer-based neural network), when a training example is presented to the network, model weights are updated. Due to such changes, the loss value associated with each training example (the one being presented as well as others) is changed. The loss measures how well the model predicts the training example's target values (usually in or derived from its last layer). There are various methods for computing the loss, depending on the task at hand (regression, classification) e.g., mean squared error (MSE), mean absolute error (MAE), cross-entropy (CE).

High loss usually implies a poor prediction. Initially, upon the start of training, the overall loss (i.e., the sum of the losses of individual training examples) is high and, it is expected that, as the training progresses, the loss decreases from its initial value. Ordinarily, the set of learning examples used to train the model is divided into three subsets: training, validation and test. The validation set is used during training usually for tuning hyperparameters and monitoring the model's performance during training to prevent overfitting, and the test set is only used to determine training quality post training. There are variations on training, such as leave-one-out type, K-Fold Cross-Validation and more.

In many training schemes, although not all, a learning example is of the form (x,y) where x denotes a vector of input features (e.g., in classification tasks the input features are usually values for attributes such as age, gender, photograph, in regression tasks the input features may represent physical attribute values or signal values etc.) and y denotes a vector of output features (e.g., in a classification task y may be a natural number in the range [1 . . . 10] when there are 10 possible classes, in a regression task y may be a real number such as 1.3, a vector of real numbers such as (−0.26, 0,1), etc.). In classification tasks, y may be called the class label. If y can be either 0 or 1, y may be referred to as a binary label. When an example (x,y) is presented to a neural network during training, x is presented in a way consumable to the network, the network's output (either directly or via interpretation) is compared to y, the loss value measuring the accuracy is computed, and model weights are adjusted based on the loss, immediately or after a batch of examples is presented and their cumulative average loss value is calculated. The aforementioned process may have certain variations depending on the neural network's architecture and task.

Many training methodologies use a variation of stochastic gradient descent (SGD) as an optimization component, for example, the Adam optimizer. Each time duration in which all training examples are presented to the model during training, is referred to as an epoch, and usually training is made up of a sequence of some l>0 epochs, E0, E2, . . . , El. Changes to the model weights may be applied after each training example is presented during training. Alternatively, a batch of examples is presented and after the whole batch is presented, weights are updated based on the batch's cumulative effect (i.e., the average of the cumulative loss of the batch's training examples). In some embodiment not all training examples are presented within each epoch.

Consider training a neural network trained on a set denoted S of training examples in the simple case of size 1 batches (of examples). When a training example denoted e is presented to the neural network, weights are updated. This weight change affects the loss of e which captures the difference between its y values and the network-computed values denoted ŷ. This weight change also may affect the loss of other examples if presented to the network in a feed forward no-training mode, i.e., just produce the output based on current weights. The classifier is trained for T steps, where for the case of size 1 batches, in each step a single example is presented to the neural network. Denote by z=(x, y) a training example from training set S where x is a set of features and y is its label. Denote by z_0 a test example from a test set U. Denote by [symbol] (w_t, z_0) the loss value of the neural network on the test example z_0 with parameters (weights) w_t, at training step t, 1≤t≤T. Here, w_t and w_{t+1} model parameters before and after, respectively, the model is updated at step t. The overall training influence of the training example z on the test example z_0 is defined as: IdealInfluence(z;z_0)=Σ_{1≤t≤T:z_t=z} ( [symbol] (w_t, z_0)− [symbol] (w_{t+1}, z_0)). This quantity may be negative, zero or positive, depending on the cumulative effect of the presentations of example z on the loss of example z_0. If the test example is identical to z, i.e., z=z_0, then IdealInfluence (z;z_0) is called the self-influence of z during training. Inventors observed that high self-influence values indicate an anomalously labeled training example, often a mislabeled example or an outlier.

At 508, during the training (i.e., by a training process), a stepwise self-influence value is computed for each adapted image and/or corresponding label (which may be adapted) (i.e., adapted record). The stepwise self-influence value indicates a loss reduction amount of the adapted record that is attributed to the presentation of the adapted record to the classifier during the training. The loss reduction amount is computed according to a loss function computed during the training.

The stepwise self-influence value of a specific adapted image may be recorded after executing a training process on multiple adapted images. Alternatively, or additionally, the stepwise self-influence value of a specific adapted image is recorded after executing the training process on adapted images.

The stepwise self-influence value of a specific adapted image may be computed after training the classifier using multiple states of the classifier saved during training, for example, checkpoints.

The multiple stepwise self-influence values for each adapted record are aggregated to obtain a self-influence value for each adapted record.

Given:
Z=(x, y) as a training example from the training set S,
T denotes the number of training steps,
z_0 as a test example from the test set Z,
[symbol] (w_t, z_0) denotes the loss value of the model on the test example z_0 with parameters (weights) w_t, at training step t,
w_t and w_{t+1} denote the model parameters before and after, respectively, the model is updated at step t,
The overall training influence of the training example z on the test example z_0 is defined as: IdealInfluence(z; z_0)=Σ_{1≤t≤T:z_t=z} ( [symbol] (w_t, z_0)− [symbol] (w_{t+1}, z_0)),
   The summation is on points in time when z is the example presented to the model.
   This formula accumulates the total reduction in loss on z_0 due to updates made to the model parameters influenced by training example z.
   Each term in the summation captures the change in the loss on z_0 because of a single update of the parameters at time t (from w_t to w_{t+1}) when the model was trained using example z.

It is noted that as defined, IdealInfluence (z; z_0) may be impractical to compute because after each parameter update the loss change of z_0 is computed, namely [symbol] (w_t, z_0)− [symbol] (w_{t+1}, z_0). Therefore, using the first two elements of a Taylor series of [symbol] (w_t+(w_{t+1}−w_t), z_0), the loss change may be approximated due to the parameters update by using the gradient vector of the loss function (applied to z_0 with respect to (w.r.t) the weights w_t at time t, as follows (the term O(∥w_{t+1}−w_t∥² indicates very small quantities as the weight change is usually a small fraction which we subsequently ignore).

LossChange=∇ [symbol] (w_t, z_0)·(w_{t+1}−w_t)+O(∥w_{t+1}−w_t∥²), where · is the dot product, therefore:

$$\text{?} ( w\_ \{ t + 1 \} , z\_ 0 ) \approx \text{?} ( w\_t , z\_ 0 ) + ∇ \text{?} ( w\_t , z\_ 0 ) \cdot ( w\_ \{ t + 1 \} - w\_t \} + O ( {‖ w\_ \{ t + 1 \} - w\_t ‖}^{2} )$$

However, the difference vector w_{t+1}−w_t=−n_t∇ [symbol] (w_t, z_t) as z_t is the presented example, where η_t is the step size (learning rate) at time t, and we use gradient descent, therefore:

$$\text{?} ( w\_ \{ t + 1 \} , z\_ 0 ) - \text{?} ( w\_t , z\_ 0 ) \approx ∇ \text{?} ( w\_t , z\_ 0 ) \cdot ( - η\_t ∇ \text{?} ( w\_t , z\_t ) ) ,$$

Both sides of the equation are multiplied by (−1), the result:

$$\text{?} ( w\_t , z\_ 0 ) - \text{?} ( w\_ \{ t + 1 \} , z\_ 0 ) \approx η\_t \cdot ∇ \text{?} ( w\_t , z\_ 0 ) \cdot ∇ \text{?} ( w\_t , z\_t )$$

Recall that:

$$IdealInfluence ( z ; z\_ 0 ) = {\sum }_{1 \leq t \leq T : z \_ t = z} ( \text{?} ( w\_t , z\_ 0 ) - \text{?} ( w\_ \{ t + 1 \} , z\_ 0 ) )$$

Therefore, the overall loss reduction of z_0 due to z can be approximated by:

$$ApproximateInfluence ( z ; z\_ 0 ) = {\sum }_{1 \leq t \leq T : z \_ t = z} η\_t ∇ \text{?} ( w\_t , z\_ 0 ) \cdot ∇ \text{?} ( w\_t , z )$$

The implied computation by the definition of ApproximateInfluence may still be impractical a dot product between ∇ [symbol] (w_t, z) and each ∇ [symbol] (w_t, z_0) is to be performed following each presentation of example z to the neural network. To mitigate this, fewer computations are performed and not after every presentation of every example. The training process may be replayed using checkpoints. A checkpoint is a recording at a certain point in time of the values of the network's parameters and hyperparameters and possibly other data. Checkpoints may be recorded during training for a variety of reasons (for example, restating a computation from a certain point).

For k checkpoints w_{t1}, w_{t2}, . . . , w_{tk} corresponding to time points t1, t2, . . . , t, it may be assumed that these time points coincide with epoch conclusions. Let η_i denote the step size (learning rate) used between checkpoints i−1 and I (for simplicity, it may be assumed that the step size is held steady between checkpoints). It may be further assumed that each training example was presented to the network exactly once between checkpoints. Since there is no access to the parameters vector at the exact time an example was presented to the network, the parameters vector may be approximated with the first checkpoint parameters vector following the actual time of presentation of the example to the network. Another approximation, denoted CPApproximateInfluence (CP stands for checkpoint) may be implemented:

$$CPApproximateInfluence ( z ; z 0 ) = {\sum }_{i = 1}^{k} η\_i ∇ \text{?} ( w\_ \{ ti \} , z\_ 0 ) \cdot ∇ \text{?} ( w\_ \{ ti \} , z )$$

There are k checkpoints, and a sum is computed using their weight vectors rather than on the weight vectors at the actual example presentation times.

Several approximation steps may be implemented. To make things even “more approximate”, in practice there is no guarantee that each example is presented once between checkpoints. Examples of further approximations that may be made include:
a low latency implementation using a vector database-based nearest neighbor search.
a random projection approximation, using a random matrix for projection.
Further optimization when the last layer is fully connected and linear. In this case, the gradient may be effectively computed just for the weights of the last layer rather than all the network's weights.

It is noted that rather than approximating the influence the aforementioned may produce “proxies” for the influence. For several applications, the proxies may suffice.

Computing influence may be useful for understanding how training examples affect the overall learning of the model. A few applications of influence are now provided:

One example is a method for locating training examples that stand out as irregular, such as an example that is mislabeled, for example, an image of a dog labeled as “cat”. When this example is presented to the network, the effect it has on the network's weights is such that it “diverts” the network away from learning that the image includes cat features towards learning that these features are dog features. When other properly labeled training examples of dogs are presented to the network, they tend to undo the effect of the mislabeled example and associate dog features with the “dog” label. In doing so, they will increase the loss of the mislabeled example as they move the weights toward predicting “dog” for the mislabeled example, contrary to its own mislabel (“cat”). Therefore, for the mislabeled example throughout the computation, all the properly labeled dog examples pull it towards predicting “dog”, increasing its loss, and it itself is the sole (or one of a minor subset of mislabeled examples) that moves the network weights toward decreasing its loss.

Self-influence denotes the amount of loss reduction an example has exerted on itself throughout training. As all the properly labeled examples (assuming they form the majority of training examples) “drive” the network closer to predicting the correct labels, the mislabeled examples induce a greater “pulling” effect on the network towards predicting their corresponding wrong labels. This greater “pulling” effect is manifested by high self-influence values. Therefore, based on the apparent correlation between label correctness and the self-influence score, one strategy for locating mislabeled examples is computing self-influence and the higher it is the higher the probability that this example is mislabeled. Technically, ApproximateSelfInfluence is defined as:

$$ApproximateSelfInfluence ( z ) = {\sum }_{1 \leq t \leq T : z \_ t = z} η\_t ∇ \text{?} ( w\_t , z ) \cdot ∇ \text{?} ( w\_t , z )$$

High self-influence scores do not only occur for mislabeled examples. An outlier is a training example that is vastly different from the “usual” training example in the class. For example, for training examples of a Sphynx cat that is properly labeled as a cat, these cats are quite different from other cats, they have no fur and very distinct facial and body features. Therefore, the Sphynx cat examples would also incur high self-influence. Therefore, ranking training examples in the order of self-influence, from high to low, highly ranked outliers may be identified.

There is yet another situation that may lead to high self-influence scores. If the data set is imbalanced there may be a class that is sparsely represented in the dataset. Intuitively, neighboring classes (with “close” features) will draw predictions towards the more heavily represented classes. In “fighting” this drawing the examples of the sparsely represented classes will tend to have higher self-influence scores.

High self-influence examples may be separated into, for example, (a) probably mislabeled examples, (b) probably outlier examples, where outlier examples (outliers) are likely to be correctly labeled training examples that are significantly different from the rest of the training examples in the training set and/or their label's class, and (c) examples from an under-represented class (an imbalance in data distribution may force some classes to “work harder” so as not to be mislabeled by the wrong class). The separation is achieved by examining the influence each example has on the overall training of other classes' examples. The separation may be performed using the following exemplary approach:
i. To handle the case of data distribution imbalance, these scores may be optionally normalized, based on the average self-influence of the training examples labeled with the class. Two exemplary methods for achieving this task include:
   a. Normalize the example's self-influence score by dividing said score by the absolute value of the average self-influence score of the class's examples to determine if the example's self-influence score is high relative to other training examples with that class label.
   b. Normalize an example's self-influence score by replacing it with the result of dividing, the difference between its self-influence score and the average self-influence score for the examples with that example's class label, by the standard deviation of self-influence scores for examples in the class of the example's label.
ii. List the training examples based on their self-influence value (score or normalized score), from high to low. Normalization may result in a different order than that without normalization, and each normalization method may induce a different ordering. It is also possible to produce weighted self-influence scores, and list accordingly, of the form w_1*rank_by_method1+ . . . +w_n*rank_by_methodn, where w_1+ . . . +w_n=1, and where method1, . . . ,methodn are distinct influence score normalization methods.
iii. The “negative influence” of a training example denoted e on a training example denoted f indicates that the total increased loss caused by example e, upon its presentation to the neural network, on example f during training. For example, if an example contributed, in total, to an increase in the loss on example f by an amount A>=0 to the examples of a class, then A is the “negative influence” of e on f. The negative influence of example e on example f may be a negative number in case example e caused a decrease in the loss of example f during training.
iv. Whereas the definition in (iii) refers to “during training”, in practice the measurement of negative influence may start after a few epochs (e.g., “warm-up” epochs) in which a substantial number of examples are presented to the neural network, possibly in batches. The “warm-up” epochs may navigate the neural network to a realm of weights where the random starting point is replaced with the “start-of” learning.
v. The impact of a high self-influence example can be analyzed in two cases: (a) its impact on members of the class of its label, (b) its impact on members of other classes. For a mislabeled example, it is likely that it negatively affects primarily two classes, the one of the “wrong” class designation with which it is labeled, and the class of its “true” class designation (the one to which it belongs given its example's characteristics). For an outlier example, it likely negatively affects the class of its own label but its effect on other classes is relatively small in comparison.
vi. The test: Given a high self-influence example with features x and label L, (x,L), compute its average negative influence, per example of a class, for each class (including class L). For example, that for a class L′, compute the negative influence that (x,L) has on each example labeled L′ in the training set and compute the average negative influence on class L′ examples.
vii. Two exemplary cases are now described:
   When the average negative influence of example e is markedly higher for just two classes-class L (example e's original designated class) and another class M—it may be deduced that e=(x,L) is highly likely to be mislabeled and its true label is M. Markedly higher may refer to the average negative influence scores example e induces are the highest for classes L and M and the next highest average negative influence class, for example class K, is at least q % lower than that of the smallest average negative influence of classes L and M. q denotes a hyperparameter, e.g., 15%.
   When the average negative influence is markedly higher for just class L (example e's originally designated class), the example is highly likely to be an outlier in class L, and L is its true label.
viii. If neither of the aforementioned two cases applies, it may be determined that the test is inconclusive and calls for a human inspection. The case in which the average negative influence is highest for class M (not originally designated) and not for class L (originally designated) may indicate a borderline example e, to be reported as such to the human inspector. For example, presented on a display and/or generating an alert.
ix. The aforementioned test calls for computing average negative influence over all classes. This may be time and computing resources consuming in the case of many classes. This computation may be made more efficient using the following exemplary sampling technique. Instead of computing negative influence on all examples of a class, a random sample from each class N (a parameter, e.g., 20 or parametrically specified by a parameter q, e.g., percentage of all examples) examples may be selected and the class average may be computed over these N examples. When the test is inconclusive, additional N examples may be sampled. When the test is still inconclusive, example e may be provided for human inspection, for example, presented on a display and/or an alert may be generated.
x. The computation of self-influence and influence on examples of other classes (cross-influence) may be coupled to the training on the dataset of examples as follows. Each time a batch is presented to the neural network during training, self-influence may be computed and recorded for each example. In addition, cross-influence between each example and each of the other examples in the batch may be computed and recorded. If a batch has k examples this implies k*k computations, where k is usually small. The aforementioned method computes self-influence precisely but cross-influence only approximately. To make the approximation more accurate, if example e has a certain influence A on example f in the same batch, then example e would have influence amount A on an example g (not in the batch) provided examples f and g are identically labeled and if examples f and g are “close”.

Closeness may be computed using the following exemplary approach. Periodically, during training, for each example e a vector v which is the vector of weights of the last (before the output layer) fully connected neural network layer, or the latest highly (u % of fully connected, u a parameter) connected layer if the last layer is not fully connected, may be extracted. Those vectors may be clustered into m clusters (m a parameter) for each class. Two examples are considered “close” if they belong to the same cluster of the clustering for their (same) class.

This approach may enable computing a good estimate of the influence of example e above not just on members of the batch but also on examples “close” to those members.

At 510, the self-influence values of the adapted records are analyzed, for example, adapted records are ranked according to the self-influence values. One or more adapted records with self-influence value meeting a requirement indicating likelihood of being anomalously labeled (e.g., threshold) may be identified.

The records of the training dataset corresponding to the identified adapted records (i.e., the records which provided the basis for generation of the identified adapted records) may be identified.

The self-influence value for the adapted record may be computed stepwise during and/or after training, and/or analyzed with respect to (i) other adapted images of the same class designation as the respective adapted image and with respect to (ii) other adapted images of a different class designation as the respective adapted image. The influence value indicates the amount of loss reduction of the other adapted image due to the presentation of the adapted image during training. In response to the analysis of the aggregation of the self-influence values with respect to (i) and (ii) indicating that the requirement of likelihood of being anomalously labeled is met, the class designation of the object of the adapted training image in the label of the image of the training dataset depicting the object may be corrected by being changed to the class designation of the different class designation. Is it noted that the requirement of likelihood of being anomalously labeled may be a different requirement than other requirements described herein. Alternatively, in response to the aggregation of the self-influence values with respect to (i) meeting the requirement and with respect to (ii) not meeting the requirement, the object of the adapted training image of the training dataset depicting the object may be identified as an outlier of the class designation of the object. The outlier may be processed, for example, left as-is, removed, or a new category may be created for the outlier.

An exemplary process is now described:
Rank training examples by their self-influence, from high to low.
Apply the outlier test, described above and/or herein, and when the training image is determined by this test to be an outlier (intuitively, largely atypical), mark the image as such.
If a image's label is different from the classifier model denoted M's predicted label when presented with this example, mark M's prediction as a (potential) remediation label associated with this example.
Output the images and their marking(s), in ranking order of self-influence from high to low.

At 512, one or more actions may be implemented based on the analysis of the self-influence values. The actions may be automatically performed, or alternatively, a recommended actions is presented on a display and implemented in response to user approval.

When the training images are ranked from high to low based on their self-influence (or a proxy for it), one or a combination of the following three options may be implemented:
Performing human reviews of some or all highly ranked examples.
Applying outlier identification techniques, described herein. Two lists of “suspects” listed in order of self-influence from high to low may be generated. One is a list of training images suspected of being mislabeled, the other is a list of training images suspected of being outliers.
Eliminating the top q % of highly ranked images (q denotes a parameter). The elimination may be followed by re-training and conducting the analysis on the modified training set. Alternatively, the elimination may be performed via an unlearning method that erases (almost all the) effects of the eliminated training examples on the model. There are several unlearning techniques, with various tradeoffs among them involving time and computing cost and degree of erasure. Some of these techniques use influence as well.
Remove images corresponding to high self-influence adapted images (e.g., above a threshold or other requirement) for creating an enhanced version of the original training dataset (also referred to herein as a reduced training dataset).
Correct the anomaly of the label of the images, for example, by correcting the class designation, assigning a class designation where one was missing, moving the bounding box, resizing the bounding box, and/or adding a bounding box where one was missing.

The images removed from the training dataset may include mislabels and/or outliers.

Images where the classifier's prediction and the label of the image are identical may be retained, even when the self-influence indicates a possible anomaly.

Influence may be used in other applications. One application is that of debugging a model's prediction. Unlike other known techniques that explain the model's output (prediction) when presented with an example based on the specific features of the example or elements thereof, influence-based techniques examine the root cause of the prediction, namely the training examples. For a specific prediction, a group of training examples that support the prediction may be identified. That is, their influence on this prediction's example is positive (referred to herein as proponents), and a group of training examples that do not support the prediction, that is their influence on this prediction's example is negative (referred to herein as opponents). By analyzing these two groups and interacting with the user, the root causes of mispredictions may be identified. Often, these are mislabeled examples, outliers or the result of gross data set imbalance. These causes may be addressed by repairing the dataset.

Training examples may be labeled by one of L classes. Alternatively, the situation may be more complex, and to apply the ‘generic’ influence analysis the influence approach is adapted to the specific setting. For example:
In computer vision (CV) applications, the example may be an image in which multiple labeled bounding boxes have been indicated. In another CV application, segmentation, some errors may be nuanced (e.g., just a few borderline pixels). Being mislabeled is implied by mislabeling specific boxes, segments or pixels, or even omitting some that should have been identified.
In Radar application, techniques for isolating misidentified objects.
In speech-to-text (STT) applications, techniques for locating suspicious segments in an audio example.

At 514, one or more features described with reference to 502-512 may be iterated. During each iteration one or more records with anomalies may be found, and corrected and/or removed from the training dataset. The next iteration starts using the training dataset with corrected and/or removed records with anomalies generated in the preceding iteration.

The iterations may be performed, for example:
For all images of the training dataset.
For all images of the training dataset but allow to interactively specify a subset of examples to view.
For a subset of the training images, for example: images labeled by a certain class, of a particular date or range of dates, supplied from a specific source and/or other possible such specifications.

The iterations may proceed while sufficiently many (e.g., according to a parameter) sufficiently high self-influence training examples (e.g., according to another parameter) are detected. There may be one or more controlling parameters that may streamline these iterations. For example, one parameter may be for determining when a training example is of high self-influence. This parameter may be, for example:
A percent denoted a1 by which the example's self-influence is higher than the average self-influence of an example or the number of standard deviations its self-influence score is from the average self-influence score for its class (i.e., label).
This parameter may be a specific value denoted a2 chosen for the training dataset.
A function of the iteration number denoted a3 of the iterative process.
A percentage denoted a4 where the example needs to be among the a4% highest self-influence examples.
A formula depending on these parameters a1-a4.
Other possibilities may be implemented.

The iterations may be terminated, for example:
When the number of images identified as being likely anomalously labeled is below a threshold denoted t1.
When the number of images identified as being likely anomalously labeled is less than t2% of the number of training images.
When in the current iteration the number of identified images to remove is less than t3% of the number of images to remove that was identified in the previous iteration.
According to a formula depending on one or more of the aforementioned parameters t1-t4.

At 516, the enhanced version of the original training dataset, which includes corrected anomalously labeled image(s) and/or with removed anomalously labeled image(s), is provided.

At 518, a machine learning model is trained on the enhanced training dataset. The machine learning model may be implemented as, for example, a classifier and/or detector, optionally based on a neural network architecture.

The trained machine learning model is predicted to perform better after training on the enhanced training dataset in comparison to being trained on the original training dataset which included one or more images with anomalies.

Alternatively, in cases where the ML model has already been trained on the original training dataset with anomalously labeled images, the trained ML model may undergo an unlearning process for unlearning the identified anomalously labeled image. The unlearning of the anomalously labeled images is predicted to improve performance of the unlearned ML model.

Some additional exemplary implementations based on the features of the method described with reference to FIG. 5 are now described. It is to be understood that one or more of the exemplary implementations described herein may be combined.

A first additional exemplary implementation is based on creating new adapted images by extracting portions of the images of the training dataset. The adapted training dataset of adapted images is created by processing each annotated image of the training dataset (e.g., one by one). Each adapted image includes an adapted training image created from a single bounding box or closed polygon on an image depicted in the training dataset by extracting portions of the image delimited by an extended bounding box (EBB) from the image. The EBB includes a portion (denoted P) of the image that includes the bounding box (denoted b) and a context area surrounding the bounding box. The adapted image includes the class designation assigned to the EBB corresponding to the single bounding box. The adapted image may be referred to as IEBB. The IEBB are optionally resized so that all the EBBs are of the same size (height and width in terms of pixels). The IEBB is added to the adapted training dataset (e.g., an output data set), for example the OIEBB dataset of image examples.

Once the adapted image(s) that is likely anomalously labeled is identified, the class designation of the object in the image of the training dataset with bounding box corresponding to the EBB of the adapted training image may be corrected to the class designation output by the classifier. Alternatively, the image corresponding to the adapted image is removed from the training dataset.

In more detail, the context of P may be parameterized, for example by:
P includes a minimal box b of the area Q that bounds the contained object.
P bounds (contains) box b and is u % larger than Q, where u is a parameter. Notably, u may be such that P includes the entire image. To help the classifier focus on the relevant object, features may be added to the EBB that act as an indicator and/or mask any other objects in the EBB, for example:
   Adding an extra channel to the existing color channels-referred to as an attention channel. One possible implementation is adding a channel in which all pixels within the bounding box of the relevant object hold “1” and all other pixels hold “0”. Another option is to fill the pixels around the center of the bounding box with values between 0 and 1, according to some decay function (e.g., exponential decay, bell curve, etc.). This may effectively “focus” the model's attention on the object in question and its label during training while also including possibly relevant context from other areas in the original image.
   Masking other objects in the EBB can be realized in various ways, including, but not limited to:
      i. Black and/or white out the EBB within the other objects' bounding boxes excluding pixels within the bounding box of interest.
      ii. Fill each color channel of the pixels within the other objects' bounding boxes, excluding pixels within the bounding box of interest, with the average value of that channel across the EBB/original image.
      iii. Replace the interior of each of the other objects' bounding boxes, excluding pixels within the bounding box of interest, with an image denoted I of identical shape (to said interior) that includes (only) “background-like” features (do not include any, whole or part, of a relevant object, e.g., I is a cropped image of the sky). Such an image I can be cropped from the current image, another image in the dataset or an image not included in the dataset. It could also be generated for each specific case using generative models, such as stable diffusion.
      iv. Any of the aforementioned i-iii for a subset of the other bounding boxes based on distance (a parameter) from the processed object and the distances from the image boundaries (other parameters).

High self-influence images in the OIEBB dataset may be found, for example, by train a classifier denoted M on OIEBB (i.e., on the adapted training dataset) to obtain a trained performant model. During training, for each training example image, the loss reduction amount for that example that is attributed to the presentations of this example to the neural network during training, i.e., stepwise self-influence. For video datasets that include track IDs per unique object across the video, the same data loading strategy may be executed during training, where a single training example is considered to be a single track instead of a single IEBB (e.g., substituting the list of IEBBs with a list of unique track IDs). Next, in each training step for each sampled track ID randomly sample an IEBB associated with it.

The stepwise self-influence values of each training example may be aggregated and/or normalized. The implementation is not necessarily limited to any specific calculation method. By way of example, this might include an initial step of aggregating and normalizing the stepwise self-influence scores within each epoch (relevant for examples that are introduced more than once per epoch), followed by an aggregation and normalization across epochs to produce a single value per training example. For example, calculating the mean of the stepwise self-influence scores within each epoch, then computing a weighted sum of these values.

A second additional exemplary implementation is based on identifying geometric mislabels, for example, mispositioned and/or misshaped bounding boxes, in the training dataset.

The adapted training dataset is created by creating adapted images that depict one or more labelling errors (i.e., anomalies). The adapted images may represent different types of labelling errors which may be possible (e.g., may exist) in the training dataset. Augmented images of the adapted images may be created by creating artificial errors, by adapting one or more bounding boxes of a subset of images of the training dataset, to generate one or more mislabeled bounding boxes and/or augmented labels representing possible labelling errors. The augmented images may be created by augmenting the bounding box and/or label of the original image of the training dataset, for example: shifting each of the delimiting boundary coordinates by a constant value, shifting the bounding box, enlarging a width and/or a length of the bounding box, and reducing the width and/or the length of the bounding box. The subset of images may be randomly selected from the training dataset. A sufficient number of such adapted images (e.g., w % of the number of the training data set examples where w is a parameter) may be created. New images (i.e., adapted images) are added to the training dataset to create the adapted training dataset (also referred to as an augmented training dataset). Each adapted image includes an augmented image and a class designation indicating the mislabeling of the bounding box in the augmented image. The classifier described with reference to FIG. 5 is trained on the adapted training dataset. The classifier (i.e., classification framework) described with reference to FIG. 5 may be used by essentially converting the geometric aspect of the problem into a semantic problem.

Alternatively, or additionally, the adapted training dataset is created by the following exemplary process: for a subset of the images of the training dataset, creating augmented images by adapting the label(s) of the subset to generate multiple augmented labels. Setting the class designation of the object in the augmented image label to a class designation (e.g., “error”) indicating the mislabeling of the bounding box. Adding the augmented images to the training dataset forming an augmented training dataset. Obtaining adapted training images from the augmented training dataset. Training a classifier over the adapted training images. For an adapted image with self-influence value meeting the requirement indicating likelihood of being anomalously labeled, correcting the bounding box of the object of the image of the training dataset, or removing the image from the training dataset.

The trained classifier will tend to classify images displaying an error with the corresponding error class (one of the new classes that were added). In turn, this will cause original dataset training images having such errors but not tagged with any of the error classes to obtain high self-influence scores. Intuitively, the artificial error classes “operate against” the original labels of such training examples. Erroneous bounding boxes may be detected. Furthermore, if the classifier trained on the augmented dataset classifies such an example as belonging to an error class, it is very likely a badly labeled example in terms of object boundaries and/or position.

For an adapted image with self-influence value meeting the requirement indicating likelihood of being anomalously labeled, the bounding box of the object of the image of the training dataset may be corrected, or the image and/or image with anomaly may be removed from the training dataset. The bounding box of the object of the training dataset may be corrected according to the class designation indicating the mislabeling of the bounding box outputted by the classifier.

A third additional exemplary implementation is based on identifying misclassifications of overlapping objects in the training dataset.

One problem with overlapping labels, i.e., the bounding boxes overlap, is that methods may fail to distinguish between their corresponding objects during the model training phase. The case of training a single-label classifier on images derived from the bounding boxes is described. The first issue is that of overlapping bounding boxes which may occur because objects are near each other in the image, even with one occluding the other. The second issue for such overlapping bounding boxes is whether the bounded objects are of the same class or not. The third issue is whether the designated classes are correct. Two specific cases that potentially impede the influence-based analysis are now described.

In a first case, two or more correct labels of different designated classes overlap in such a way that their bounding boxes largely overlap, and their designated classes are correct. This may lead the method described with reference to FIG. 5 to wrongly identify examples with correct class designation as probably mislabeled. For example, for the case of two labels, where one box is occluding the other box—the classifier's attention is likely to be focused on the occluding object's features when either object's example is presented (after being extracted) to the classifier during training. This will cause the example corresponding to the occluded object to gain a high self-influence score during training, since the features perceived by the classifier (the occluding object's pixels) do not match its label (occluded object's class). Therefore, the occluded object will very likely be flagged as a probably mislabeled object (even though it is not). This outcome is therefore problematic.

In a second case, two or more labels of the same designated classes overlap in such a way that their bounding boxes largely overlap where at least one of their designated classes is incorrect. This may lead the method described with reference to FIG. 5 to wrongly identify examples with a wrong class designation as probably correct. For example, for the case of two labels-when two labels of the same designated class overlap in such a way that both their bounding boxes significantly overlap (perhaps because both naturally occur together) and one of them is misclassified, the single-label classifier's attention will likely to focus on just the correctly classified object's features when either object's example is presented to the classifier during training. The reason for this is that under the presented image classification paradigm, in case of an example (image) containing two different objects but labeled with the class of only one of them, a “well trained” classifier presented with this example will tend to focus on the features that match its label. For example, suppose the image contains overlapping dog and cat objects and both are labeled as “dog”. Due to overlapping, both derived images, one for bounding box, will contain a significant portion of the dog object. Both images are labeled “dog” and based on these dog features the classifier will tend to “agree”. This will cause the “disregarded” object's example (the cat-bounding-box-derived image) to gain a low self-influence score during training, since the features perceived by the classifier (the “regarded” object's, dog, pixels) match their designated class (both objects' class, “dog”). Therefore, it is very unlikely for such a “disregarded” object to be flagged as a probably mislabeled instance object even when in fact it is. This outcome is therefore problematic.

These issues are caused by the fact that the outcome of the previously outlined influence-based analysis described with reference to FIG. 5 is given for each training example only with respect to a single class. At least one embodiment increases the scrutiny with which the influence analysis is performed in a way that enables a clear separation between overlapping labels in an image. Two exemplary processes are now described.

A first process is based on using multiple binary classifiers.
i. Generate an adapted training dataset (e.g., the OIEBB dataset as described herein, or another adapted training dataset described herein). The training dataset includes one or more images, where each image depicts at least two overlapping objects and/or at least two overlapping bounding boxes.
ii. Create m duplicates of the adapted training dataset, each associated with a single class, where m is the number of classes (object categories, or class designations). The adapted training dataset may include the subset of (new artificial) error classes described herein.
iii. For each duplicated image of each duplicated adapted training dataset, label each object with a first category indicating true when the label of the object in the image of the adapted training dataset matches the class designation of the object in the duplicated image. Label each object with a second class designation indicating false when the label of the object in the image of the adapted training dataset is different than the class designation of the object in the duplicated image, In other words, for each duplicate, relabel each object (image and/or record) with a first indication (e.g., “true”) if its label in the adapted training dataset matches the duplicate's associated class and with a second label (e.g., “false”) otherwise. For example, if adapted image e's label is “dog”, then its duplicate in the dataset for the classifier for class “cat” will be labeled “false”, on the other hand, if example f's label is “cat”, then its label in that (class specific) dataset would be “true”.
iv. For each “true” example in each duplicate dataset find and discard any “false” examples, originating from the same original image, whose bounding boxes “highly” overlap said “true” adapted image's bounding box in the original image, given some measure and threshold value. For example, distance between box centers, pairwise IOU (intersection over union) values, etc. For example, by using clustering algorithms, such as DBSCAN, or by creating a k-d tree of the labels to obtain candidate subsets, after which the overlap measure is applied within each candidate subset (k-d neighborhood).

In more detail:

A k-d tree (k-dimensional tree) is a data structure which may be used to organize points in a k-dimensional space. It enables efficient querying of spatial data, such as finding the nearest neighbors or points within a specific region.

Represent Boxes with Points: Each bounding box can be represented by its center point or corner point in the k-d tree.

Use Range Queries: Perform a range search in the k-d tree to find points (bounding boxes) whose coordinates fall within a certain range of the target box.

Filter for Overlap: After retrieving candidate boxes via the range query, perform a more precise intersection-over-union (IoU) calculation to measure the actual overlap. Retain boxes with IoU above a threshold.
v. Iterate features 504-510 of FIG. 5 for each of the m datasets, each with a dedicated binary classifier model. In other words, train a respective binary classifier on each duplicated adapted training dataset. During the training, a stepwise self-influence value is computed for each image. The stepwise self-influence value indicates a loss reduction amount of the image that is attributed to the presentation of the image to the respective binary classifier during the training. This process may enable identifying, for each class, high self-influence objects with that class's label, as well as identifying likely “true” label classes for mislabeled objects.
vi. For a respective image in each duplicated adapted training dataset labelled with the first category, find and remove another image labelled with the second category corresponding to a same image of the respective image, where a bounding box of the another image overlaps according to a requirement a bounding box of the respective image.
vii. Assign zero to the self-influence value of a removed image. Assign all discarded adapted images a self-influence score of 0 with respect to the class associated with their corresponding dataset duplicate. This is a “bureaucratic” step to keep all images in the final ranking by self-influence, for each single-label-classifier.
viii. Provide images with self-influence value meeting the requirement indicating likelihood of being anomalously labeled for correction and/or removal.

A second exemplary approach is based on a multi-class classifier.
i. Identify at least one image of the training dataset depicting at least two overlapping bounding boxes. For each image find subsets of objects whose bounding boxes “highly” overlap, given some measure and threshold value. For example, distance between box centers, pairwise IOU (intersection over union) values, etc. For example, by using clustering algorithms, such as DBSCAN, or by creating a k-d tree of the labels to obtain candidate subsets, after which the overlap measure is applied within each candidate subset (k-d neighborhood).

In more detail:

A k-d tree (k-dimensional tree) is a data structure that may be used to organize points in a k-dimensional space. It may enable efficient querying of spatial data, such as finding the nearest neighbors or points within a specific region.

Represent Boxes with Points: Each bounding box can be represented by its center point or corner point in the k-d tree.

Use Range Queries: Perform a range search in the k-d tree to find points (bounding boxes) whose coordinates fall within a certain range of the target box.

Filter for Overlap: After retrieving candidate boxes via the range query, perform a more precise intersection-over-union (IoU) calculation to measure the actual overlap. Retain boxes with IoU above a threshold.
ii. For each identified image, replace the at least two overlapping bounding boxes with a single new bounding box that at least covers a union of the overlapping at least two bounding boxes, and assign a multi-class label designation created as a union list of the class designations of the overlapping at least two bounding boxes. In other words, for each subset, in each image replace the subset's labels (bounding boxes and class annotations) with a single label composed of a (new) bounding box that at least covers the union of the subset's bounding boxes and a class equal to the union list of the subset's classes thereby creating a multi-class label. Intuitively, this refers to—for each class in this list, the single bounding box contains at least one instance of that class.
iii. For each object not included in any subset consisting of overlapping objects (i.e., a non-overlapping object), adjust the multi-class label to be a list of length l including (only) its original class.
iv. Generate the adapted training dataset described with reference to FIG. 5 and/or other implementations described herein (e.g., the OIEBB dataset). The adapted training dataset includes an image of the single new bounding box and the multi-class label designation.
v. Implement features described with reference to 504-510 of FIG. 5 by training a multi-class classifier on the adapted training dataset. During the training, a class-wise self-influence value for each image is computed in a stepwise manner, where the class-wise self-influence value indicates a loss reduction amount of the image that is attributed to the presentation of the image to the multi-class classifier during the training. The loss function with which to compute the self-influence measure is decomposed by class, thus maintaining class-wise influence measures per object. This can be implemented, for example, by using binary cross entropy (BCE) loss per class (e.g., per output node in a neural network). Self-influence scores corresponding to [training images, class] pairs, may be obtained. For example, for a training example e that has a ‘dog’ object and the output node corresponding to the ‘dog’ class is 0.6 then the BCE loss for the pair [e, ‘dog’] is −(1·log(0.6)+(1·1)·log(1−0.6))=−(log 0.6).
vi. Provide images with aggregated class-wise self-influence value meeting the requirement indicating likelihood of being anomalously labeled for correction and/or removal.

Either of the two aforementioned exemplary approaches generates a set of self-influence scores corresponding to each of the training images with respect to each of the possible classes (as opposed to only a single class in the method of FIG. 5). The result, as desired, would be that subsets of labels of different classes with overlapping bounding boxes (from the original dataset) where none are misclassified gaining low self-influence scores, and subsets of labels of the same class with overlapping bounding boxes (from the original dataset) where at least one of them is misclassified, to gain high self-influence scores.

In more detail, in the occluded object image (first situation, correct labels, different classes), by using the first approach described above, multiple classifiers, the image corresponding to the correctly labeled occluded object, that previously gained a high self-influence score with respect to its given class, will gain a low self-influence score with respect to any other (than its own) class. This is because it will either be discarded (in case of the occluding object's class) or tagged “false” (for other classes other than its own), in which case it behaves as any ordinary correctly labeled image. Additionally, it will gain a low self-influence score with respect to its own class, since the occluding object's image, which essentially acts as an “opponent” of the occluded object's image, is discarded from the dataset duplicate used to train the binary classifier of the occluded object's class, preventing the accumulation of a high self-influence score. Similarly, using the second exemplary approach described above, the “unified” image including both the occluding and the occluded objects and labeled with both their classes will be treated as any ordinary correctly labeled image presented to a multi-class classifier, resulting in a low self-influence score across all classes.

Considering the example of two overlapping labels of the same class where one is misclassified (second situation), by using the first exemplary approach described above, the image corresponding to the misclassified object, that previously gained a low self-influence score, will likely gain a high self-influence score with respect to its true class, since it will be labeled as “false” in the dataset duplicate used to train the binary classifier of its true class. Additionally, it will gain a low self-influence score with respect to all other classes, since either it will be tagged as “false”, in which case it will behave as any ordinary correctly labeled image, or even for its own (wrong) class (it will be tagged “true”), because of the present features of the correctly classified object. Similarly, following the second exemplary approach described above, the “unified” image which includes both the correctly classified and misclassified objects and labeled with their (same) designated class will be treated as any ordinary incorrectly labeled image presented to a multi-class classifier, resulting in a high self-influence score with respect to the mislabeled class and low self-influence scores across all other classes.

Another exemplary approach is described for the case of one or more images of the training dataset depicting at least two overlapping objects, where a first object at least partially covers a second object and/or where there are at least two overlapping delimiting boundaries. The exemplary approach includes the steps of: Creating a number of duplicates of the adapted training dataset, where the number corresponds to the number of class designations. The j'th duplicate dataset is associated with the j'th class designation where j ranges over class designations. For the j'th duplicated image of each duplicated adapted training dataset, labelling each object with a first class designation indicating true when the label of the object in the image of the adapted training dataset is the same as the class designation associated with the j'th duplicate dataset, and labelling each object with a second class designation indicating false when the label of the object in the image of the adapted training dataset is different than class designation associated with the j'th duplicate dataset. A respective binary classifier is trained on each duplicated adapted training dataset. During the training, a stepwise self-influence value for each image is computed. The stepwise self-influence value indicates a loss reduction amount of the image that is attributed to the presentation of the image to the respective binary classifier during the training of said classifier. For a respective image in each duplicated adapted training dataset labelled with true, another image in this duplicated adapted training dataset labelled with false corresponding to the same image in the image training dataset is found and removed, where a bounding box of the other image overlaps according to a requirement for a bounding box of the respective image. A value of zero is assigned to the self-influence value of the removed image. Images with self-influence value meeting the requirement indicating likelihood of being anomalously labeled for correction or removal are provided.

A third additional exemplary implementation is based on identifying images (images) with missing objects in the training dataset.

The third additional exemplary implementation is based on defining an image classification problem on which a self-influence analysis (e.g., as described with reference to FIG. 5) is implemented, as a proxy for finding images in which not all objects of interest have been labeled. An adapted training dataset is created such that an image in which an (embedded) object that is not detected would have high self-influence. The third additional exemplary implementation is as follows
a. Create a proxy dataset (i.e., the adapted training dataset):
   i. A first sub-dataset is created by creating a copy of each image of the images of the training dataset overlaid with a visual representation of the class designations of the objects. In other words, for each of the original images (image and associated labels) create a copy of the image overlaid with a visual representation of its associated labels. The overlay can be done by, for example: drawing the actual boxes or box centers on the image, adding a single channel binary representation of the boxes or box centers, etc.
   ii. A subset of images of the training dataset is selected. New images are created for the subset by excluding a subset of labels of the subset of images. A second sub-dataset is created for the new images. In other words, choose a subset of the original training dataset (e.g., uniformly and/or randomly). For each image in this subset create a new image (i.e., adapted image) by excluding a subset of its respective labels (including their bounding boxes) and implement the previous step (i) on this subset. The choice of labels to exclude can be done uniformly and/or randomly either across the entire set of existing labels in the image or across each set of existing same-class labels in the image separately, where the number of labels to exclude can be either a preset value, implied by a percentage parameter, or randomly chosen as well.
   iii. A first set of proxy images (i.e., adapted images) is created from the first sub-dataset labelled with a label indicating fully annotated. A second set of proxy images is created from the second sub-dataset labelled with a label indicating partially annotated. The adapted training dataset is implemented as a proxy training dataset that includes the first set of proxy images and the second set of proxy images. In other words, label the examples generated in the first step (i) as “fully annotated” and the examples generated in the second step (ii) as “partially annotated”. The proxy dataset consists of the examples in the first and second step.
b. Features described with reference to 504-512 are implemented as described with reference to FIG. 5, where the adapted training dataset is implemented as the proxy dataset. For an image with self-influence value meeting a requirement indicating likelihood of being anomalously labeled, the image of the image is provided for correction or removing the image from the training dataset. Consider an image (i.e., image) denoted e from the images of the first step labeled “fully annotated”. Suppose image e has an object denoted o that was not boxed and labeled. The trained classifier would tend to classify e as “partially annotated”. However, because e's label is different, the result will be high self-influence for example e. This will enable a quick examination of the images suspected of having unannotated (i.e., undetected) objects.

A possible extension of the aforementioned process is to generate a multi-class classification proxy dataset by adding the “fully/partially annotated” labels to each new image, per class. Then, step (b) above can be executed with either modifications for calculating the self-influence per class in a multi-class classification setup or in the training of multiple single-label classifiers—one per class setup.

A fourth additional exemplary implementation is based on identifying unlabeled objects in images in the training dataset.

The adapted training dataset is implemented as (i.e., including an) objectness dataset. An objectness image (i.e., an adapted image) of the objectness dataset (i.e., of the adapted training dataset) includes an image of the training dataset and an objectness map of the image of the training dataset. The objectness map is implemented as a mask over pixels, which including a binary representation of existence of objects of interest in the image indicated by a center of mass position of each object in the image. The objectness map may be implemented as a 0-1 mask that includes the binary representation of the existence of objects (of interest) in the image indicated by the position (center of mass) of each object. A pixel designates a position in space and optionally a class designation. For example, to disregard the object classes (object categories) or if there is only one type of class, the objectness map may be implemented as a 2D array of shape W×H. Where W and H denote the image width and height (in pixels), respectively, in which the objects' pixelwise positions (bounding box centers) hold “1” and all other pixels hold “0”. Alternatively, another implementation of the objectness map is a 3D array of shape W×H×C, where the 3rd dimension C denotes the number of classes in the original dataset, in which the objects' pixelwise positions hold “1” only in the appropriate class dimension (“channel”). For example, if the center of mass of an object is at positions (5,10) and its class is class number 2, then the pixel at position (5,10,2) is 1. For positions of the form (x,y,z) pixels, a pixel value may be either 0 or 1. The objectness dataset includes the objectness images, where each objectness image includes an image (input features) and its corresponding objectness map (its label).

Training of the classifier is implemented by training an objectness predictor model on the objectness dataset. The objectness predictor model is trained using an objectness loss function that measure a distance between the objectness map of the objectness image and a predicted objectness map outputted by the objectness predictor model. The objectness loss function measures the distance between the desired (i.e., the objectness map label) and the actual output of the objectness predictor model. Examples of objectness losses include binary cross entropy loss, focal loss, quality focal loss, varifocal loss, and more. Each of the objectness losses may be calculated per pixel of the predicted objectness map. The objectness predictor model is trained to generate pixelwise binary classifications across a predicted objectness map with a same shape as the objectness label (map) of the objectness image. Each output node of the objectness predictor model may correspond to a different pixel.

The stepwise self-influence values may be computed pixelwise, each input image pixel may have as having its own loss. The pixelwise self-influence may be accumulated using approaches described herein (e.g., with reference to FIG. 5) to enable to detect possible missing object positions indicated by pixels with high self-influence that are not near a possibly corresponding label. Corresponding labels may be determined by some distance metric relating the pixel to the image's bounding boxes (e.g., Euclidean distance between a pixel of interest and some detected object's bounding box center). In case the objectness map includes class channels—the W×H×C objectness map presented in (i)—bounding boxes with a matching class may be check (e.g., only those bounding boxes), i.e., following the example above, a pixel at position (5, 10, 2) can only be associated with bounding boxes of class 2.

To illustrate the aforementioned approach, consider the W×H case (no classes indicated). Consider an image in which a 3×5 pixel rectangular object is not detected at all. Each of these 15 pixels would be labeled by “0” in the object, but, in case for example binary cross entropy is used, the classifier will likely tend towards predicting “1” in the central pixel. In this case the outcome would be a high self-influence score for this central pixel, marking it as a likely suspect for the center of a missing object's bounding box.

For an objectness image with pixels having an aggregated self-influence value meeting a requirement indicating likelihood of a missing object, a bounding box for the object of the objectness image may be added. Alternatively, the image corresponding to the objectness image may be removed from the training dataset. The requirement may indicates that the pixel having aggregated self-influence value meeting the requirement is at least a predefined distance away from another bounding box center of mass.

A fifth additional exemplary implementation is based on identifying misclassifications and/or outliers in a semantic segmentation training dataset.

For a dataset of annotated images wherein each pixel in the image is labeled, for example in one of m labels (classes) L1, . . . ,Lm, an “image” of all labels is referred to herein as a “semantic mask”. The following exemplary process solves the technical challenge of locating those pixels that are misclassified or part of outliers:

Respective class-wise connected components are generated by analyzing the labels of a respective semantic mask indicating designated class per pixel of each respective image. For each respective component of the class-wise connected components, a proxy object-detection-like label that includes a bounding box equal to a minimal bounding rectangle of the component is generated. The adapted image includes the proxy object-detection-like label. Pixels of the image that belong to each respective component are distinguished from pixels of the image that do not belong to the respective component. The adapted image further includes a class designation for the component according to the class designation of the pixels of the component.

In more detail:
Read the annotated images one by one.
For each image decompose its corresponding semantic mask to class-wise connected components. Treat these class-wise components as the basic dataset examples.
For each component produce a proxy object-detection-like label where its bounding box is equal to the minimal bounding rectangle of the component and its class is the same as that of the component pixels'. From here on out the influence-based analysis for each of the components is performed via the proxy labels.
To perform the analysis, implement the features 504-510 described with reference to FIG. 5 (or other embodiments described herein), by adapting the following features accordingly:
   Add an extra channel to the existing color channels—i.e., an attention channel. One possible implementation is to add a channel, similar to the customary R,
G and B channels, in which all pixels belonging to the relevant component hold “1” and all other pixels hold “0”.
   Masking other objects in the adapted image (e.g., EBB) may be implemented in various ways, including, but not limited to:
      i. Black or white out all pixels that don't belong to the relevant component.
      ii. Fill each color channel of the pixels that do not belong to the component of interest with the average value of that channel across the EBB or original image.
      iii. Implement any of the above i and ii only for a subset of the other pixels/components based on distance (e.g., a parameter) from the processed component and the distances from the image boundaries (according to other parameters).
Map the suspected misclassifications/outliers back to their corresponding class-wise connected components.

A sixth additional exemplary implementation is based on identifying geometric mislabels (e.g., mispositioned and/or misshapen segments) in a semantic segmentation training dataset.

New error images (i.e., adapted images) are generated by generating copies of at least a subset of the images of the training dataset and generating a labelling error for each respective component of the copies. The error images are added to the adapted training dataset. The error images may be generated by generating copies of the adapted images described with reference to the fifth additional exemplary implementation.

The new error images may define new classes of images, each representing a different type of labeling error. The classifier described herein may be used by essentially converting the geometric aspect of the problem into a semantic problem. The process may include selecting images (images) from the original dataset (e.g., randomly) and creating new augmented copies of the images that include one or more of the labeling errors. For example, add an adapted image (based on a training image(s) in the training dataset) in which a single class-wise connected component is shifted and/or rotated relative to its original position and/or has at least partially/locally been deformed (either inwards or outwards, orthogonal to its original boundary) so as to be misaligned with the corresponding component in the image. A sufficient number of such adapted images may be created (e.g., w % of the number of the training dataset images where w denotes a parameter) and add the adapted images to the original training dataset of training images to create an augmented dataset (i.e., the adapted training dataset). A classifier is trained the augmented dataset, as described herein. The trained classifier will tend to classify images displaying an error with the corresponding error class (one of the new classes that were added). In turn, this will cause adapted images corresponding to original training dataset images having such errors but not tagged with any of the error classes to obtain high self-influence scores. Intuitively, the artificial error classes “operate against” the original labels of such original training images. This enables identifying erroneous components. Furthermore, if the classifier trained on the augmented dataset classifies such a component as belonging to an error class, it is very likely a badly labeled example in terms of its boundaries and/or position.

The connected components contain pixels of the same class designation, and may include at least one of:
Pixels having a common dimension value and another value differing by one.
Two pixels having a value in each dimension differing by no more than one, and does not include:
   A set of no more than a predefined number (q) of pixels that when classified to a different class than its class designation split the component into two or more components.

Connected components may be formed in several ways. For example, two pixels may be considered connected if they have a common dimension value and the other value differs by 1, e.g. (5,2) and (5,3). In another example, two pixels may be considered connected if their value in each dimension differs by at most 1, e.g., (1,2) and (2,3). When there is a set of at most a number denoted q pixels such that classifying them with another class splits a component into 2 or more components, then the component may be split into these 2 or more components and the at most q pixels may be randomly added to one or more of these 2 or more components. For example, if q=1 then if there is a pixel whose classification with a different class splits the component into two components, then the component is replaced with two components and the splitting pixel is associated to one of these two components. The rationale is that this split component is suspect.

Referring now back to FIG. 6, the flowchart is for the method for identifying objects missing labels in a training dataset for training a machine learning model.

At 602, a training dataset is accessed and/or received and/or generated.

The training dataset includes multiple images. Each image depicts one or more objects and a label comprising a collection of label vectors (or tuples or other data structure). At least one image depicts multiple objects. Each label vector corresponds to a specific object in the image and includes a class designation and geometric coordinates defining a bounding box (or other shape) for the corresponding specific object.

Additional exemplary details are described, for example, with reference to 502 of FIG. 5.

At 604, an adapted training dataset of adapted images is optionally generated from the training dataset, by blurring the objects in the bounding boxes of the images of the images of the training dataset. An adapted image is generated by the blurring of the image of the image of the training dataset. Each identified object within a bounding box may be blurred, for example, to an average pixel color of its surroundings. The blurring may be performed such that all labeled objects in the original image are no longer present in the adapted image.

The blurring may be performed by using a generative image model, e.g., stable diffusion.

Alternatively, no blurring is performed.

At 606, the adapted training dataset is fed into an object detector model.

The object detector model may be trained on the training dataset, and/or be a pre-trained model trained to detect objects in images. Alternatively, the object detector model may be implemented as a large language model (LLM), for example, by asking the LLM what objects it can identify in the input adapted image.

In embodiments in which no blurring is performed, the LLM may be asked to detect missing objects in an inputted image labelled with one or more bounding boxes, for example, the LLM is asked if there are objects in the image that are not within a bounding box.

At 608, the object detector model generates an indication of a detected object on an adapted image fed into the object detector model. Optionally, the object detector model generates a bounding box on the adapted image with blurring. The bounding box includes the blurred region therein.

When the object detector model detects any object in an adapted image, the object detector model has detected an object that was not detected in the original image. This object exists in the original image but was not detected, i.e., it is a missing object, or is an unlabeled object.

At 610, one or more actions may be taken, optionally automatically, in response to the object detector model generating the bounding box on the adapted image with blurring. For example, mapping the generated bounding box to the image corresponding to the adapted image, and removing the image corresponding to the adapted image from the training dataset.

Additional exemplary embodiments for detecting errors in a training dataset for training a machine learning model are now described.

An object may be associated with a bounding box of pixels in an image and is labeled by at least one class out of a finite number of classes. An anomalously labeled object may be: a mislabeled or an outlier object or an object belonging to an underrepresented in the training set collection of objects of same classes.

In some embodiments, a computer implemented method of detecting an anomalously labeled object in a training example from a dataset of image training examples identifying objects for a neural network, comprises extracting a plurality of single object images comprising bounding boxes and their contents and labels from a plurality of image training examples, forming a new dataset comprised of said extracted objects as training examples, and training a neural network classifier on said new dataset, during said training recording information for computing the reduction of loss function value of a first training example upon presentation of training examples to the neural network, computing for said first training example its self-influence equaling the sum of said loss function values of said first training example upon its presentation to the neural network, and based on said self-influence being high identifying said first example as comprising an anomalously labeled object.

In some embodiments, a computer implemented method of detecting an anomalously labeled segmented component in a training example from a dataset of segmented image training examples identifying segments for a neural network, is provided. Each pixel in the segmented image is labeled by one of a finite number of pixel types and/or object identifiers. An object includes a connected component of segmented pixels in an image having the same type and/or same object identifier. An anomalously labeled object includes a component that can be extended to additional pixels or that should have been decomposed to two or more components and/or objects. The method comprises extracting a plurality of single object images comprising bounding boxes and their contents and labels from a plurality of segmented image training examples, forming a new dataset comprised of said extracted objects as training examples, training a neural network classifier on said new dataset, where during said training recording information for computing the reduction of loss function value of a first training example upon presentation of training examples to the neural network, computing for said first training example its self-influence equaling the sum of said loss function values of said first training example, and based on said self-influence being high identifying said first example as containing an anomalously labeled component.

In some embodiments, a computer implemented method of detecting an anomalously labeled training example from a dataset of labeled training examples for a neural network, is provided. A training example includes one or more features and of one or more labels. A neural network model is trained on said set of labeled training examples. During training information for estimating or computing the loss reduction induced by each presentation of a training example on each training example in the training dataset is recorded. For each training example the average loss reduction it induces on each class's example is computed and optionally normalized. A training example where the computed average is high relative to that of other examples for its own class and for all other classes is identified as anomalously labeled.

Optionally, for the said identified as anomalously labeled training example said computed average is high relative to only the class of said identified as anomalously labeled training example, and wherein said identified as anomalously labeled training example is further identified as an outlier example.

Optionally, said computed average is high relative to its identified as anomalously labeled example class and relative to only one other class, and wherein said identified as anomalously labeled training example is further identified as a mislabeled example.

Optionally, said one other class's label is identified as a likely correct label for said identified as mislabeled training example.

Optionally, said one other class's label is identified as a likely correct label for said identified as mislabeled training example.

Optionally, said normalized is computed by dividing said average loss reduction by a number equal to the mean of the averages of loss reduction computed over all examples in its class.

Optionally, said normalized is computed by dividing the difference between said reduction and said average loss reduction by a number equal to the standard deviation of the averages of loss reduction computed over all examples in its class.

In some embodiments, a computer implemented method of locating an object in an image that is not identified in a training example from a dataset of image training examples identifying objects for a neural network, is provided. An object includes a bounding box of pixels in an image and is labeled by at least one class out of a finite number of classes. The method includes creating a new dataset of image training examples. The new dataset includes the initial training examples with the addition of a subset of augmented examples. Each augmented example is derived from a copy of an example from the initial training examples where one or more of its labels' geometric parameters have been altered to mimic one or more of mispositioned and/or misshapen bounding boxes.

Some additional features and/or technical details of one or more of the aforementioned embodiments are now described:

At the core of modern computer vision systems are deep learning architectures, particularly Convolutional Neural Networks (CNNs), which are well-suited to process image data. CNNs excel due to their ability to capture spatial hierarchies in images using convolutional layers. CNNs are the most widely used architectures in computer vision tasks. A CNN typically includes convolutional layers, pooling layers, and fully connected layers (of artificial units (neuron) interconnected via weights). The convolution operation allows for feature extraction from images, and pooling reduces the dimensionality of the data while preserving important features. Some examples of CNN architectures include:
AlexNet (2012): A groundbreaking CNN model that won the ImageNet competition and highlighted the power of deep learning for image classification tasks.
VGGNet (2014): Known for its simplicity, VGGNet used very small (3×3) convolutional filters and was instrumental in building deeper networks.
ResNet (2015): Introduced the concept of residual learning, which allowed for very deep networks by addressing the vanishing gradient problem.
Inception (2014): Utilized “inception modules,” where multiple convolution operations are performed in parallel, allowing the network to capture features at various scales.
Generative Adversarial Networks (GANs): GANs, proposed in 2014, consist of two networks: a generator that creates images and a discriminator that evaluates them. GANs have shown tremendous potential in image generation and enhancement tasks.
YOLO (You Only Look Once): YOLO is a fast and efficient object detection model (2016). It treats object detection as a regression problem, identifying objects and their bounding boxes simultaneously. YOLO's speed makes it suitable for real-time applications, and its variants like YOLOv3 and YOLOv4 are widely used today.
UNet (2015): UNet is a popular architecture used for segmentation tasks. It employs a contracting path (encoder) to capture context and an expansive path (decoder) to enable precise localization. UNet is particularly effective in biomedical image segmentation.
Vision Transformers (ViT): In 2020, Dosovitskiy et al. introduced the Vision Transformer, which applied the transformer model directly to image data. Unlike CNNs, which process images through convolutions, ViT divides an image into patches, flattens them into sequences, and feeds them into a standard transformer model.

Embodiments described herein may be implemented for identifying anomalies in the training datasets for training CNNs, such as the aforementioned architectures and/or other architectures.

Exemplary computer vision tasks which use models trained on training datasets for which embodiments described herein may identify anomalies include:

1. Object Detection and Labeling: Object detection involves identifying the presence of objects in an image and drawing bounding boxes around them. These boxes are often (but not always) rectangular, possibly rotated, and indicate an image region enclosing the object. In object detection and labeling, the system may not only detects the object but may also assign a class (out of a fixed finite number of classes) to each detected object. This task is central to applications like self-driving cars and video surveillance.

### Notable Models:

YOLO (You Only Look Once): YOLO, previously mentioned, is a single-stage object detection algorithm that simultaneously predicts bounding boxes and class labels for objects in an image. It is known for its speed, making it suitable for real-time object detection.
Faster R-CNN: Faster R-CNN is a two-stage model that first proposes regions of interest using a Region Proposal Network (RPN) and then classifies and refines these regions. It offers high accuracy, though at a slower speed than YOLO.
SSD (Single Shot MultiBox Detector): SSD is another single-stage object detection model that detects objects at multiple scales using feature maps at different resolutions, achieving a balance between speed and accuracy.

2. Image Classification: Image classification refers to the process of assigning a label to an entire image. The CNN architectures previously mentioned (e.g., AlexNet, VGG, ResNet) have been instrumental in achieving state-of-the-art results in this domain.

3. Semantic Segmentation: An image is usually represented as a rectangular array of pixels. This task involves labeling every pixel in an image with a class. While image classification provides a single label for an entire image, segmentation models generate more detailed results by classifying each pixel. Popular models for segmentation include UNet, DeepLab, and Fully Convolutional Networks (FCNs).

4. Instance Segmentation: Unlike semantic segmentation, which labels every pixel, instance segmentation not only identifies object categories but also distinguishes between different instances of the same object class. For example, it segments bicycle pixels and further specifies bicycle_1, bicycle 2 and so on in case of multiple such objects. Mask R-CNN is a common architecture for instance segmentation.

5. Handling Multiple Labels and Objects Not Found: One challenge in computer vision is detecting multiple labels per object, which can occur when an object belongs to different categories or serves multiple functions. Networks must also contend with situations where expected objects are absent from images, requiring robustness in detecting outliers or missing data.

Vision Transformer for Multi-class Classification: A standard ViT model can be adapted for multi-class tasks by using a multi-class loss function. The transformer's ability to capture relationships between distant regions in an image helps in situations where labels depend on different parts of the image.

Embodiments described herein may identify anomalies in other types of data used to train machine learning models, for example:

1. Radar Data Analysis: AI techniques applied to radar data enable autonomous systems to perceive the environment beyond visual information. For example, Radar-based object detection is crucial in self-driving cars due to its ability to detect objects in poor visibility conditions (e.g., fog, darkness).

2. EKG and EEG Analysis: Beyond images, AI models are used to process time-series data from electrocardiograms (EKG) and electroencephalograms (EEG). These data sources present unique challenges as they involve waveform analysis, but techniques such as Recurrent Neural Networks (RNNs) and Long Short-Term Memory Networks (LSTMs) are commonly applied to detect anomalies or classify patterns in these bio-signals. Such data may be represented as three-dimensional images, and applying vision techniques to analyze the data.

3. Computerized Tomography (CT) Analysis: implemented as two-dimensional slices or three-dimensional images, applying vision techniques to analyze the data.

Incorporating temporal information from videos presents additional complexities. For example, tracking moving objects across frames requires both spatial and temporal analysis. 3D-CNNs and LSTMs are often used for video understanding tasks such as action recognition and anomaly detection. Video data also introduces the challenge of handling frame-to-frame dependencies, making real-time processing essential for applications like surveillance and autonomous driving. Similar difficulties are also present in CT analysis although unlike video, the number of frames may be fixed. At least one embodiment described herein may be used to reduce or prevent anomalies in the temporal information by identifying anomalies in the training data, as described herein.

Extending computer vision to multimodal datasets introduces the challenge of integrating heterogeneous data sources such as images, text, audio, and sensor streams. For instance, aligning visual features with descriptive language is essential in applications like visual question answering and image captioning, while combining camera feeds with LiDAR or radar data improves robustness in autonomous systems. Multimodal models must capture both intra-modal patterns (e.g., spatial hierarchies in images) and inter-modal relationships (e.g., temporal or semantic alignment across text and vision). This integration requires specialized fusion mechanisms-such as cross-attention in transformers—that can balance contributions from each modality. Misalignment across modalities (e.g., conflicting labels between text and images) introduces additional complexity, making label quality and consistency critical in multimodal datasets. At least one embodiment described herein may be used to reduce or prevent misalignment across modalities by identifying anomalies in the training data, as described herein.

Embodiments described herein may be used to identify anomalies in training datasets and improve models (e.g., performing computer vision) across numerous fields, for example:
Autonomous Vehicles: Object detection and segmentation are crucial for understanding the environment in real-time. Network architectures like YOLO and Mask R-CNN are integral in detecting pedestrians, vehicles, and road signs.
Healthcare: Medical imaging, including X-rays, MRIs, and CT scans, leverages computer vision for diagnostics, e.g., identifying tumors. Models like UNet are used for segmentation in radiological images.
Retail: Computer vision is used for checkout-free shopping, where cameras track the movement of products in real time.
Security: Surveillance systems employ object detection and video analysis to identify suspicious activities.

Referring now back to FIG. 7,

At 701, i=1; initialize an empty dataset, e.g., IEBB.

At 705, read the i'th annotated images.

At 709, j=1 if there are bounding boxes in the I'th annotated image.

At 714, read the j'th bounding box and its class designation(s).

At 719, mark an extended bounding box (EBB) around each object.

At 723, optionally, add an extra channel to the existing color channels.

At 726, optionally, mask out other objects in the EBB.

At 729, extract the EBB and form a labeled image consisting solely of the EBB with the label being that of the bounded object designated class(es), call it IEBB.

At 730, add the IEBB to the output data set OIEBB.

At 740, are there additional bounding boxes in image i?

At 745, yes, increment j by 1.

At 748, no, are there additional images?

At 754, yes, increment i by 1.

At 759, no, train a classifier M on IEBB and image loss reduction amounts during training for each example.

At 763, train a classifier M on IEBB and image its loss reduction amounts during training for each training example, call this stepwise self-influence.

At 767, aggregate and normalize the stepwise self-influence values of each training example, call it self-influence score.

At 771, rank training examples by their self-influence scores, from high to low, to form a list.

At 775, apply the outlier test to each training example and if the training example is determined by this test to be an outlier mark the example as such.

At 780, if an example's label is different from the model M's predicted label(s) for this example, mark M's prediction as a (potential) remediation label associated with it.

At 784, output the ranked list and/or self-influence scores and/or their markings and/or remediation labels for a specified subset of the training examples, in rank order or reverse rank order.

Referring now back to FIG. 8, at 807, given a high self-influence example with features x and label L, (x,L), compute its average negative influence, per example of a class, for each class (including class L).

At 809, is the average negative influence of example e is markedly higher for just two classes, class L (example e's original class) and another class M?

At 815, yes, deduce that e=(x,L) is highly likely to be mislabeled and its true label is M.

At 820, no, is the average negative influence markedly higher for just class L?

At 830, yes, deduce that the example e is highly likely to be an outlier in class L, and L is its true label.

At 840, no, deduce the test is inconclusive and calls for a human inspection, a possible borderline example.

Referring now back to FIG. 9, at 907, introduce new classes of examples, each representing a different type of labeling error.

At 909, choose examples from the original dataset (e.g., randomly) and creating new augmented copies that include one or more of the labeling errors.

At 915, add these examples to the original data set of training examples to create an augmented dataset.

At 919, train a neural network M on the augmented dataset.

At 923, mark high self-influence original training examples and or original examples M predicts of an error class as probably geometrically mislabeled or erroneous.

Referring now back to FIG. 10, at 1007, (i) for each of the original examples of image and associated labels, create a copy of the image overlaid with a visual representation of its associated labels.

At 1010, choose a subset of the original dataset examples and for each example in this subset create a new example by excluding a subset of its respective labels (bounding boxes).

At 1015, (ii) for each of the new examples of image and associated labels, create a copy of the image overlaid with a visual representation of its associated labels.

At 1019, label the examples generated in the first step (i) as “fully annotated” and the examples generated in the second step (ii) as “partially annotated”. The proxy dataset consists of the examples generated in the first and second steps.

At 1023, train a neural network model M on the proxy dataset where each training example is either marked as “fully annotated” (0) or “partially annotated” (1).

At 1029, mark high self-influence original training examples as suspected of containing undetected objects.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant machine learning models will be developed and the scope of the term machine learning model is intended to include all such new technologies a priori.

As used herein the term “about” refers to +10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A computer implemented method of removing and/or correcting at least one anomaly in a training dataset for training a machine learning model, comprising:
wherein the training dataset comprises a plurality of images, each image depicting a plurality of objects, and a collection of labels, each label corresponding to a specific object in a specific image and comprising a class designation selected from a plurality of class designations and geometric coordinates defining a delimiting boundary of the corresponding specific object within the corresponding specific image;
generating an adapted training dataset of adapted images by extracting portions of the image delimited by the respective delimiting boundary for each image of the training dataset and/or by generating new images and/or adapting existing images for depicting candidate anomalies of the images and corresponding adapted labels comprising the class designations of the objects associated with each adapted image;
training a classifier on the adapted training dataset wherein during or after the training a stepwise self-influence value for each adapted image is computed, the stepwise self-influence value indicating the amount by which the classification loss on the adapted image is reduced as a result of changes in the tunable parameters of the classifier made in a training step and attributed to the presentation of the adapted image itself;
aggregating a plurality of the stepwise self-influence values for each adapted training image to obtain a self-influence value for each adapted training image; and
for a certain adapted training image with self-influence value meeting a requirement indicating high likelihood of being anomalously labeled, for the object corresponding to said adapted training image, correcting a perceived anomaly in an indicated anomalously labeled image of the training dataset corresponding to the certain adapted training image by correcting the class designation and/or the bounding box of the object of the indicated anomalously labeled image, or removing the indicated anomalously labeled image from the training dataset.

2. The computer implemented method of claim 1, further comprising training the machine learning model on a training dataset with corrected anomalously labeled images.

3. The computer implemented method of claim 1, further comprising:
accessing a trained machine learning model previously trained on the training dataset; and
applying an unlearning process to the trained machine learning model for unlearning the indicated anomalously labeled image.

4. The computer implemented method of claim 1, wherein the delimiting boundary of a specific object within a specific image from the training dataset is a bounding box or a closed polygon.

5. The computer implemented method of claim 1, wherein the stepwise self-influence value of a specific adapted image is recorded after executing a training procedure on a plurality of adapted images.

6. The computer implemented method of claim 1, wherein the stepwise self-influence value of a specific adapted image is computed after training the classifier using a plurality of states of the classifier using checkpoints saved during training.

7. The computer implemented method of claim 1, wherein each adapted image is created from a single bounding box or closed polygon on an image included in the training dataset by extracting portions of the image delimited by an extended bounding box (EBB) including a portion of the image that includes the bounding box and a context area surrounding the bounding box or closed polygon, the adapted training image label is the class designation corresponding to the single bounding box.

8. The computer implemented method of claim 7, wherein the class designation of the object in the image of the training dataset with bounding box corresponding to the EBB of the adapted training image is corrected to the class designation outputted by the classifier.

9. The computer implemented method of claim 1, further comprising:
computing stepwise during or after training the influence value for the adapted image with respect to (i) other adapted images of the same class designation as the respective adapted image and with respect to (ii) other adapted images of a different class designation as the respective adapted image;
said influence value indicating the amount of loss reduction of the other adapted image due to the presentation of the adapted image during training;
in response to an aggregation of a plurality of the influence values separately with respect to (i) and (ii) meeting a requirement indicating a second likelihood of being anomalously labeled, correcting the class designation of the object of the adapted training image in the label of the image of the training dataset containing the object to the class designation of the different class designation; and
in response to an aggregation of a plurality of the influence values with respect to (i) meeting the requirement and with respect to (ii) not meeting the requirement, marking the object of the adapted training image of the image of the training dataset containing the object as an outlier object of the class designation of the object.

10. The computer implemented method of claim 1, wherein the adapted training dataset is created by:
for a subset of the plurality of images of the training dataset, creating a plurality of augmented images by adapting the at least one label of the subset to generate a plurality of augmented labels, setting the class designation of said object in the augmented image label to a class designation not in plurality of class designations indicating the mislabeling of the bounding box;
adding said augmented images to the training dataset forming an augmented training dataset;
obtaining adapted training images from said augmented training dataset;
wherein training comprises training the classifier over said adapted training images;
for an adapted image with self-influence value meeting the requirement indicating likelihood of being anomalously labeled, correcting the bounding box of the object of the image of the training dataset, or removing the image from the training dataset.

11. The computer implemented method of claim 10, wherein the plurality of augmented images are created by augmenting the at least one label, wherein augmenting is selected from: shifting each of the delimiting boundary coordinates by a constant value, and enlarging and/or shrinking the delimiting boundary.

12. The computer implemented method of claim 10, wherein the bounding box of the object of the image in the training dataset is corrected via a user interface according to the class designation of the bounding box outputted by the classifier on an image with self-influence value meeting the requirement.

13. The computer implemented method of claim 1,
wherein at least one image of the training dataset depicts at least two overlapping objects wherein a first object at least partially covers a second object and/or at least two overlapping bounding boxes;
creating a number of duplicates of the adapted training dataset, the number corresponding to the number of the plurality of class designations, wherein the j'th duplicate dataset is associated with the j'th class designation where j ranges over class designations;
for the j'th duplicated image of each duplicated adapted training dataset, labelling each object with a first class designation indicating true when the label of the object in the image of the adapted training dataset is the same as the class designation associated with the j'th duplicate dataset, and labelling each object with a second class designation indicating false when the label of the object in the image of the adapted training dataset is different than class designation associated with the j'th duplicate dataset,
wherein training comprises training a respective binary classifier on each duplicated adapted training dataset, wherein during the training, a stepwise self-influence value for each image is computed, the stepwise self-influence value indicating a loss reduction amount of the image that is attributed to the presentation of the image to the respective binary classifier during the training of said classifier;
for a respective image in each duplicated adapted training dataset labelled with true, find and remove another image in this duplicated adapted training dataset labelled with false corresponding to the same image in the image training dataset, wherein a bounding box of the another image overlaps according to a requirement for a bounding box of the respective image,
assigning zero to the self-influence value of a removed image; and
providing images with self-influence value meeting the requirement indicating likelihood of being anomalously labeled for correction or removal.

14. The computer implemented method of claim 1, further comprising:
identifying at least one image of the training dataset depicting at least two overlapping bounding boxes;
for each identified image, replacing the at least two overlapping bounding boxes with a single new bounding box that at least covers a union of the overlapping at least two bounding boxes, and assigning a multi-label class designation created as a union list of the class designations of the overlapping at least two bounding boxes,
wherein the adapted training dataset includes an image of the single new bounding box and the multi-class label designation;
training comprises training a multi-class classifier on the adapted training dataset, wherein during the training, a class wise self-influence value for each image is computed in a stepwise manner, the class wise self-influence value indicating a loss reduction amount of the image that is attributed to the presentation of the image to the multi-class classifier during the training; and
providing images with aggregated class-wise self-influence value meeting the requirement indicating likelihood of being anomalously labeled for correction or removal.

15. The computer implemented method of claim 1, further comprising
creating a first sub-dataset, by creating a copy of each image of the plurality of images of the training dataset overlaid with a visual representation of the labels of the plurality of objects, and creating a first set of proxy images from the first sub-dataset labelled with a label indicating fully annotated image;
selecting a subset of images of the training dataset, creating new images for the subset by excluding a subset of labels of the subset of images, and creating a second sub-dataset for the new images, and creating a second set of proxy images from the second sub-dataset labelled with a label indicating partially annotated image;
generating the adapted training dataset including a proxy training dataset including the first set of proxy images and the second set of proxy images,
wherein the classifier is trained on the adapted training dataset;
for a proxy image with self-influence value meeting a requirement indicating likelihood of being anomalously labeled, providing the corresponding image of the images of the training dataset for correction or removing the corresponding image from the training dataset.

16. The computer implemented method of claim 1, further comprising:
generating the adapted training dataset including an objectness dataset from the training dataset, wherein an objectness image of the objectness dataset includes an image of the training dataset and an objectness map of the image of the training dataset, wherein the objectness map comprises a mask over pixels including a binary representation of existence of objects of interest in the image indicated by a center of mass position of each object in the image;
wherein a pixel designates a position in space and optionally a class designation;
wherein training the classifier comprises training an objectness predictor model on the objectness dataset using an objectness loss function that measures a distance between the objectness map of the objectness image and a predicted objectness map outputted by the objectness predictor model,
wherein the objectness predictor model is trained to generate pixelwise binary classifications across a predicted objectness map with the same shape as the objectness map of the objectness image,
wherein the stepwise self-influence values are computed pixelwise,
for an objectness image with pixels having aggregated self-influence value meeting a requirement indicating likelihood of a missing object, adding a bounding box for the object of the objectness image, or removing the image corresponding to the objectness image from the training dataset.

17. The computer implemented method of claim 16, wherein the requirement further indicates that the pixel having aggregated self-influence value meeting the requirement is at least a predefined distance away from another bounding box center of mass.

18. The computer implemented method of claim 1, further comprising:
generating respective class-wise connected components by analyzing the plurality of labels of a respective semantic mask indicating designated class per pixel of each respective image,
for each respective component of the class-wise connected components, generating a proxy object-detection-like label including a bounding box equal to a minimal bounding rectangle of the component,
wherein the adapted image includes the proxy object-detection-like label wherein pixels of the image that belong to each respective component are distinguished from pixels of the image that do not belong to the respective component, the adapted image further includes a class designation for the component according to the class designation of the pixels of the component.

19. The computer implemented method of claim 18, further comprising:
creating error images by generating copies of at least a subset of the adapted images and generating a plurality of labelling errors for each respective copy of the copies, and
adding the error images to the adapted training dataset.

20. The computer implemented method of claim 18, wherein a connected component contains pixels of the same class designation and includes at least one of:
(i) pixels having a common dimension value and another value differing by one,
(ii) two pixels having a value in each dimension differing by no more than one, and does not include:
(iii) a set of no more than a predefined number q of pixels that when classified to a different class than its class designation split the component into two or more components.

21. A computer implemented method of labelling objects that are missing labels in a training dataset for training a machine learning model, comprising:
wherein the training dataset comprises a plurality of images, each image depicting a plurality of objects labelled and a label comprising a collection of label vectors, each label vector corresponding to a specific object in the image and including a class designation and geometric coordinates defining a bounding box for the corresponding specific object;
generating an adapted training dataset of adapted images by blurring the plurality of objects of the plurality of images of the training dataset;
feeding the adapted training dataset into an object detector model; and
in response to the object detector model generating a bounding box on an adapted image with blurring, at least one of: mapping the generated bounding box to the image corresponding to the adapted image, and removing the image corresponding to the adapted image from the training dataset.

22. A system for removing and/or correcting at least one anomaly in a training dataset for training a machine learning model, comprising:
at least one processor executing a code for:
wherein the training dataset comprises a plurality of images, each image depicting a plurality of objects and a collection of labels, each label corresponding to a specific object in a specific image and comprising a class designation selected from a plurality of class designations and geometric coordinates defining a delimiting boundary of the corresponding specific object;
generating an adapted training dataset of adapted images by extracting the portion of the image delimited by the bounding boxes for each image of the training dataset and/or by generating new images and/or adapting existing images for depicting anomalies of the images;
training a classifier on the adapted training dataset, wherein during or after the training, a stepwise self-influence value for each adapted image is computed, the stepwise influence value indicating the amount by which the classification loss on the adapted image is reduced as a result of changes in the tunable parameters of the classifier made by executing a training procedure on the adapted image itself;
aggregating a plurality of the stepwise self-influence values for each adapted image to obtain a self-influence value for each adapted image; and
for a certain adapted image with influence value meeting a requirement indicating likelihood of being anomalously labeled, correcting at least one label in an anomalously labeled image of the training dataset corresponding to the certain adapted image by correcting the class designation and/or the bounding box of the object of the anomalously labeled image, or removing the anomalous image from the training dataset.
